(19) United States
(12) Patent Application Publication
(10) Pub. No.: US 2026/0027932 A1
(43) Pub. Date: Jan. 29, 2026

(54) CHARGING STATION FOR CHARGING AN ELECTRIC VEHICLE

(71) Applicant: U.S. VENTURE, INC., Appleton, WI (US)

(72) Inventor: JERRY DANIEL MILLER, West Allis, WI (US)

(21) Appl. No.: 18/996,306

(22) PCT Filed: Mar. 25, 2024
(86) PCT No.: PCT/US2024/021313

§ 371 Date: Jan. 17, 2025

Related U.S. Application Data
(60) Provisional application No. 63/491,878, filed on Mar. 23, 2023.

(51) Int. Cl. B60L 53/57; B60L 1/00; B60L 53/16; B60L 53/30; B60L 53/51; B60L 53/60; H02J 7/35

(52) U.S. Cl. CPC B60L 53/57; B60L 53/16; B60L 53/30; B60L 53/51; B60L 53/60; B60L 1/003; B60L 2210/30; H02J 7/35

(57) ABSTRACT

A system for charging electric vehicles (EVs) includes a generator powered by a fuel supply, a charging dispenser configured to electrically connect with the EVs to charge the EVs via a power output from the generator, and an auxiliary power circuit electrically connected with the generator and including a power conductor that is configured to provide a first circuit path and a second circuit path adapted for connection to a first additional power source and a second additional power source, respectively. The power conductor is further configured to selectively power auxiliary components of the system via one of the generator, the first circuit path, or the second circuit path.

### CROSS-REFERENCES TO RELATED APPLICATIONS

The present application is a national stage entry of International Application No. PCT/US2024/021313, filed Mar. 25, 2024, which claims the benefit of and priority to U.S. Provisional Application Ser. No. 63/491,878, filed Mar. 23, 2023, each of which is incorporated herein by reference in its entirety for any and all purposes.

### BACKGROUND

The present disclosure is related to charging stations for electric vehicles (EV). In particular, a charging station for charging one or more batteries of an EV.

The market and sales of EVs has greatly expanded in recent years. However, the expansion of the EV market also requires an expansion of the infrastructure to support these vehicles that are dependent on an electrical charging source. For example, while the range that an EV can travel on a single charge has grown significantly in recent years, a driver of the vehicle must still plan appropriately to ensure that the range of recharging an EV will be sufficient to reach the next charging station.

Building new conventional EV charging stations takes significant planning and is largely based on existing infrastructure, such as an established gas station (or other suitable location) and the availability of sufficient electrical power. Currently, without the existing infrastructure in place, there are limitations for rapidly deploying new conventional EV charging stations. In reality, the installation of new power substations, transformers, high power lines, corresponding regulatory hurdles, and related infrastructure to support conventional EV charging stations, it can take between two to eight years to get a conventional EV charging station operational.

There are other problems with existing infrastructure and conventional EV charging stations. The current electrical grid can be subject to brownouts or even blackouts during time periods of high demand for electricity, which results in an inconsistent or unpredictable power supply. Similarly, electricity prices may fluctuate based on demand, e.g., peak time-of-use can increase the cost of electricity from the grid, and, as such, high demand time periods may be potentially cost prohibitive for EV users.

Moreover, the high costs associated with peak demands are, in fact, often intentional, due to constraints on the electrical grid to provide more incremental power at those times. These high costs are intended to lower overall grid demand. In the case of EVs, an EV driver may not have the choice of waiting to recharge at off-peak hours, which can cause blackouts or the use of peaking power plants or “peaker plants,” which are commonly dependent on fossil fuels.

Along with high and fluctuating costs for the electricity itself, current infrastructure requirements result in long lead times for the infrastructure to be built or expanded. That is, the time to get additional power to a prospective new charging site, as well as getting EV chargers, transmission lines, e.g., switchgear lines, and transformers installed, can be extensive. For example, it is estimated that certain areas in the state of California may have up to a five year wait time for infrastructure, such as new power substations, to support EV chargers at various sites.

Costs for establishing conventional EV charging stations at remote locations or seasonal sites can be prohibitive, as well. While it may be advantageous to have an EV charging station at, for examples, a national or state park, at concert or fairgrounds, or at sporting events, the costs of providing infrastructure to those sites may be cost prohibitive, such as, due to such sites experiencing only seasonal or intermittent use.

These issues may limit the range an EV driver may be willing to drive, or simply limit the range for EV drivers in particular areas or regions. While there may be service vehicles developed to provide an emergency charge for EVs, this is not a practical operating solution over time.

While the aforementioned issues are of concern to an owner of one or more EVs for personal use, these issues are more acute for owners and managers of large fleets of EVs. In particular, these challenges can limit the flexibility of scheduling specific routes and timing of those routes, and the ability to support special events and holiday seasons, where routes need to be changed or increased. Further, hot, cold, or inclement weather can significantly strain cost calculations for EV fleets, as these events can decrease the efficiency of each EV and thus significantly increase the electricity cost for charging such EV.

The fuel used to generate the electricity is also relatively dependent on the use of coal, with an average of around 22% of coal being the source to produce the energy, and amounts as high as 92% or more to generate the electricity. Source U.S. Department of Energy, https://afdc.energy.gov/vehicles/electric_emissions.html. Thus, it would be beneficial for EV charging stations to provide a net carbon reduction.

Accordingly, in view of the aforementioned deficiencies of conventional EV charging stations, a need exists for an improved EV charging station that can be quickly deployed without requiring existing electrical energy supply infrastructure, such that the EV charging stations can be strategically located based on need rather than existing infrastructure while also being more environmentally friendly compared to conventional EV charging stations.

### SUMMARY

The present disclosure is directed towards a portable charging station for charging an electric vehicle (EV) that can readily be deployed and redeployed wherever needed regardless of the availability of a connection to an electrical grid. For example, the portable charging system can include a generator that can couple to an external fuel supply (e.g., gas mains, gas tanks, etc.) to produce electrical power for vehicles or other infrastructure. In some cases, the system can include a plurality of charging ports for vehicles (e.g., a level-two charger, level-three charger, or combinations thereof), or other types of external power connections (e.g., an outlet or other power connection). The charging system may also include auxiliary power, such as a battery, solar panels, wind turbines, etc. A controller of the charging system can manage corresponding electronic circuitry (e.g., power modules, charging dispensers, etc.) to control a supply of power from the charging system. Lending to the portable nature, the various components of the charging system can be supported on or within a container (e.g., an intermodal or other type of portable container).

According to an aspect of the disclosure, a system for charging at least one electric vehicle (EV) may include a generator powered by a fuel supply to provide an alternating current (A/C) power output. The system may also include a modular charging dispenser electrically connected with the generator and configured to electrically connect with the at least one EV to charge the at least one EV via the A/C power output from the generator. The modular charging dispenser may have a power dispensing capacity that is variably customizable and may include a charging dispenser input that receives the A/C power output from the generator, a plurality of power modules that each receive at least a portion of the A/C power output from the charging dispenser input, and a charging dispenser output in electrical communication with each power module of the plurality of power modules and configured to provide at least a portion of the A/C power output from the plurality of power modules to the at least one EV to charge the at least one EV. The power dispensing capacity of the modular charging dispenser may be variably customizable based on a number of power modules of the plurality of power modules that are included in the modular charging dispenser. The system may further include an auxiliary power circuit electrically connected with the generator and including a power conductor configured to provide a first circuit path adapted for connection to a first additional power source and a second circuit path adapted for connection to a second additional power source, the first and second additional power sources being independent of the generator. The system may also include one or more auxiliary components in electrical communication with the power conductor to power the one or more auxiliary components, and a controller in electrical communication with the generator, the charging dispenser, and the power conductor. The power conductor may be further configured to selectively power the one or more auxiliary components via one of: the generator, the first circuit path, or the second circuit path.

In some examples, the auxiliary power circuit may be electrically connected with the generator in parallel with the charging dispenser. The power conductor may comprise a transfer switch that may be configured to be moveable between a first configuration, in which the one or more auxiliary components are powered via the generator or the first circuit path, and a second configuration, in which the one or more auxiliary components are powered via the second circuit path. The controller may be configured to, based on signals received from at least one of the first and second additional power sources, cause the transfer switch to move between the first and second configurations.

In some implementations, the first additional power source may comprise at least one battery that powers the one or more auxiliary components via the first circuit path independent of the generator and the second additional power source. The system may further include a third power source that may be configured to recharge the at least one battery, the third power source including at least one of: at least one solar panel that may be configured to recharge the at least one battery independent of the A/C power output from the generator and the second additional power source, and at least a portion of the A/C power output from the generator.

In some examples, the second additional power source may comprise an A/C power input that may be removably connectable to the second circuit path to power the one or more auxiliary components via the second circuit path independent of the generator and the first additional power source. The power conductor may further comprise a voltage adjuster in electrical connection with the generator and the transfer switch, wherein the voltage adjuster may be configured to modify the A/C power output from the generator to an A/C power supply that may be provided to the transfer switch to power the one or more auxiliary components. The voltage adjuster may be a transformer configured to step down the A/C power output.

In some implementations, the first additional power source may comprise at least one battery, and the A/C power supply from the voltage adjuster may be provided to the transfer switch to power the one or more auxiliary components or to the at least one battery to recharge the at least one battery. The power conductor may further comprise a voltage adjuster in electrical connection with the generator and the transfer switch, the voltage adjuster being configured to modify the A/C power output provided by the generator to provide an A/C power supply, and an inverter in electrical connection with the voltage adjuster and the transfer switch, the inverter being configured to, with the transfer switch in the first configuration, selectively power the one or more auxiliary components via the A/C power supply from the voltage adjuster or the first circuit path.

In some examples, the fuel supply may be renewable natural gas or compressed natural gas. The one or more auxiliary components may include one or more of: a light source, a thermostat, a humidistat, an electrical outlet, or a heating, ventilation, and air conditioning (HVAC) system. The power dispensing capacity of the charging dispenser may be about 30 kilowatts (kW) to about 3,000 kW, inclusive, about 30 kW to about 1,000 kW, inclusive, or about 200 kW to about 600 kW, inclusive.

In some implementations, each of power modules of the plurality of power modules may be configured to modify the A/C power output as a direct current (D/C) power output that may be provided to the at least one EV. The modular charging dispenser may further comprise one or more charging ports that may be electrically connected to the charging dispenser output and may be configured to electrically connect to the at least one EV. The controller may be in electrical communication with the plurality of power modules of the charging dispenser, and the controller may be further configured to, based on signals received from the charging dispenser, variably control a power output provided by each charging port of the one or more charging ports via control of the plurality of power modules.

In some examples, at least some of the plurality of power modules may be configured to selectively modify the A/C power output as a direct current (D/C) power output that may be provided to the at least one EV. The controller may be configured to, based on signals received from the charging dispenser, operate the one or more charging ports as a Level 2 charger or a Level 3 charger. The controller may be configured to, based on signals received from the charging dispenser, operate each of the one or more charging ports as a Level 2 charger.

In some implementations, the generator may be configured to operate with a prime running power rating and the A/C power output may be at least about 100 KW. The generator may comprise a plurality of generators, and the controller may be further configured to determine a present load of the charging dispenser and control the plurality of generators based on the present load of the charging dispenser.

In some examples, the system may further include a fourth power source in electrical communication with the charging dispenser, and the controller may be further configured to determine a present load of the charging dispenser and control the fourth power source based on the present load to provide a supplemental power output to the charging dispenser in addition to the A/C power output from the generator. The fourth power source may comprise at least one supplemental battery that may be rechargeable via the third power source or the generator.

In some implementations, the system may be further configured to electrically connect with an external electrical system to power the external electrical system via the A/C power output from the generator. The fuel supply may be a fuel pipeline that may be external to the system.

The foregoing general description of the illustrative embodiments and the following detailed description thereof are merely exemplary aspects of the teachings of this disclosure and are not restrictive.

### BRIEF DESCRIPTION OF DRAWINGS

FIG. 1 is a schematic diagram representation of an exemplary charging system for charging at least one electric vehicle (EV) according to examples of the present disclosure.

FIG. 2 is a perspective view of an exemplary charging station for EVs, including a charging system as illustrated in FIG. 1, according to examples of the present disclosure.

FIG. 3 demonstrates the charging station of FIG. 2 being loaded onto the back of a flatbed truck for delivery.

FIG. 4 depicts an overhead view of the charging station of FIG. 2 upon being delivered to a location where the charging station will be used.

FIG. 5 is a schematic diagram representation of the charging station of FIG. 2.

FIG. 6 is a cut-away side view of the charging station of FIG. 2.

FIG. 7 is a cut-away overhead view of the charging station of FIG. 2 showing the internal arrangement of the charging station.

FIG. 8 is an overhead view of another exemplary configuration of the charging station of FIG. 2 connected to a gas tank according to examples of the present disclosure.

FIG. 9 is a flow chart showing various potential arrangements of the charging station of FIG. 2 in accordance with aspects of the present disclosure.

FIG. 10 is an overhead plan view of the charging station of FIG. 8.

FIG. 11 is another exemplary arrangement of the charging station similar to that shown in FIG. 9 with a different fuel tank arrangement.

FIG. 12 is yet another exemplary arrangement of the charging station similar to those shown in FIGS. 10 and 11 with yet another different fuel tank arrangement.

13A-13C are diagrammatic representations of various exemplary charging systems of the present disclosure having multiple charging docks included in the charging system.

FIG. 14 is a perspective view showing the internal arrangement of an exemplary power unit of the charging system of FIG. 5 according to examples of the present disclosure.

FIG. 15 is an electrical flowchart showing the power unit of the charging station connected to the power dispenser.

FIGS. 16A and 16B show circuit diagrams for another exemplary charging system for a charging station of the present disclosure.

FIGS. 17A and 17B show circuit diagrams for yet another alternative exemplary charging system for a charging station according to examples of the present disclosure.

FIG. 18 demonstrates an electric vehicle being recharged using a charging station according to examples of the present disclosure.

FIG. 19 demonstrates the replacement of supply tanks of a charging station of the present disclosure.

FIG. 20 demonstrates the replacement of the supply tanks of the charging station of FIG. 19, with the supply tanks being situated upon a pallet.

FIG. 21 demonstrates the supply tanks of the charging station of FIG. 19 being refilled on site.

FIG. 22 illustrates a charging station with a fuel supply being a fuel pipeline connection according to examples of the present disclosure.

FIG. 23 demonstrates an arrangement of a plurality of EVs surrounding a charging station, such as the charging station of FIG. 21, according to examples of the present disclosure.

FIG. 24 is a schematic view of exemplary arrangement of two charging stations in connection with a plurality of EVs.

FIG. 25 demonstrates a charging station in connection with an external power system of a mobile home according to examples of the present disclosure.

FIGS. 26A and 26B are schematic diagram representations of another example charging system for charging EVs according to examples of the present disclosure.

FIG. 27 is a perspective view of a charging station for charging EVs, including a charging system as illustrated in FIGS. 26A and 26B, according to examples of the present disclosure.

FIG. 28 is a front elevation view of the charging station of FIG. 27.

FIG. 29 is a side view of the charging station of FIG. 27.

FIG. 30 is a side view of the charging station of FIG. 27 with a first side door of a station housing removed.

FIG. 31 is a cross-sectional view taken along line 31-31 of FIG. 28.

FIG. 32 is a cross-sectional view taken along line 32-32 of FIG. 27.

FIG. 33 is a cross-sectional view taken along line 31-31 of FIG. 28 that illustrates an exemplary alternative arrangement of the charging station of FIG. 27 according to examples of the present disclosure.

FIG. 34 is a cross-sectional view taken along line 32-32 of FIG. 27 that illustrates the exemplary alternative arrangement of the charging station of FIG. 33.

FIG. 35 is a cross-sectional view taken along line 31-31 of FIG. 28 that illustrates yet another exemplary alternative arrangement of the portable charging station of FIG. 27 according to examples of the present disclosure.

FIG. 36 is a cross-sectional view taken along line 32-32 of FIG. 27 that illustrates the exemplary alternative arrangement of the charging station of FIG. 35.

FIG. 37 is a side plan view of the housing of the charging station of FIG. 27 with a first side door of a station housing removed that illustrates the exemplary alternative configuration of the charging station of FIG. 35.

FIG. 38 is a schematic representation of a method for deploying a charging station to a target location for charging EVs at the target location, including a charging station as illustrated in FIGS. 2-4 and 27-37, according to examples of the present disclosure.

FIG. 39 is a schematic representation of a method for charging an EV, including a charging station having a charging system as illustrated in FIGS. 26A and 26B, according to examples of the present disclosure.

FIG. 40 is a schematic representation of a method for powering one or more auxiliary components of a charging station, including a charging station having a charging system as illustrated in FIGS. 26A and 26B, according to examples of the present disclosure.

FIG. 41 is a schematic representation of a method for operating a charging station according to examples of the present disclosure.

### DETAILED DESCRIPTION

Although the disclosure hereof is detailed and exact to enable those skilled in the art to practice the disclosed technology, the examples herein merely exemplify the disclosed technology which may be implemented in other specific structures. While the preferred implementation has been described, the details may be changed without departing from the scope of the present disclosure.

As used herein, unless otherwise limited or defined, the term “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

Unless otherwise specified or limited, the terms “about” and “approximately,” as used herein with respect to a reference value, refer to variations from the reference value of ±15% or less (e.g., ±10%, ±5%, etc.), inclusive of the endpoints of the range. Similarly, the term “substantially equal” (and the like) as used herein with respect to a reference value refers to variations from the reference value of less than ±30% (e.g., ±20%, ±10%, ±5%) inclusive. Where specified, “substantially” can indicate in particular a variation in one numerical direction relative to a reference value. For example, “substantially less” than a reference value (and the like) indicates a value that is reduced from the reference value by 30% or more, and “substantially more” than a reference value (and the like) indicates a value that is increased from the reference value by 30% or more.

Some discussion herein refers to “Level 1,” “Level 2,” and “Level 3” electric vehicle (EV) or plug-in hybrid electric vehicle (PHEV) charging capabilities, which refer to a particular standard defined by the Society of Automotive Engineers. See SAE J1772: 2017, Electric Vehicle and Plug in Hybrid Electric Vehicle Conductive Charge Coupler, Society of Automotive Engineers (Oct. 13, 2017) (defining a common EV/PHEV and supply equipment vehicle conductive charging method including operational requirements). Accordingly, as used herein, the term “Level 1” refers to an EV or PHEV charger having a 120 volt (V) alternating current (AC) voltage and a 1 kilowatt (KW) power output, the term “Level 2” refers to an EV or PHEV charger having a 208-240 V AC voltage and a 7-19 kW power output, and the term “Level 3” refers to an EV charger having a 400-1,000 V direct current (DC) voltage and a 50-420 kW power output. Further, reference herein to a charger for an EV is intended to also include reference to such charger for a PHEV.

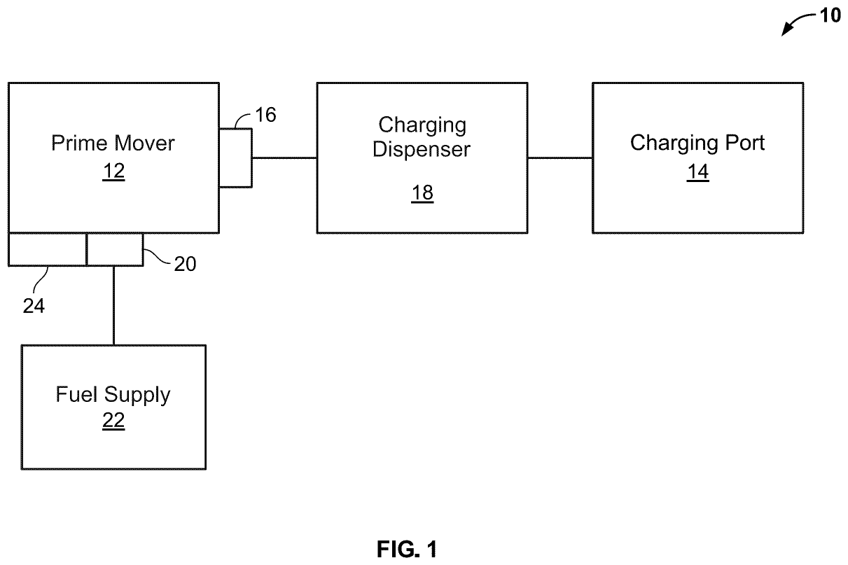

Turning now to FIG. 1, an exemplary charging system 10 for charging one or more EVs is illustrated. The charging system 10 generally includes a power source, such as a prime mover 12, and at least one electric vehicle supply equipment (EVSE) or charging port 14 in electrical communication with the prime mover 12 and configured to electrically connect with the one or more EVs to charge the one or more EVs via power from the prime mover 12. More specifically, the at least one charging port 14 is in electrical communication with a power output 16 of the prime mover 14 such that the at least one charging port 14 is powered by the prime mover 12. In some cases, a charging dispenser 18 may be disposed electrically between the prime mover 12 and the at least one charging port 14.

The prime mover 12 generally is configured to operate without connection to a power grid to power the at least one charging port 14. Thus, the prime mover 12 can be one of various types of prime movers known in the art, such as, e.g., an alternating current (A/C) generator, a direct current (D/C) generator, a linear generator, a microturbine, among others. In the illustrated example, the prime mover 12 has a fuel input 20 in communication with a fuel supply 22, which powers the prime mover 12. In some examples, a gas meter 24 may be in fluid connection with the fuel input 20 of the prime mover 12 to measure or monitor flow of fuel to the fuel input 20. The type of fuel provided by the fuel supply 22 can vary depending on the type of prime mover 12 that is utilized in the charging system 10. In some examples, the fuel supply 22 is a natural gas pipeline and the prime mover 12 is configured to operate via natural gas. In others examples, the fuel supply 22 can be compressed natural gas.

Referring still to FIG. 1, the charging system 10 can be configured to operate with varying degrees of charging capabilities, such as, e.g., via the charging dispenser 18 or a controller (not shown) of the charging system 10. For example, in some implementations, the charging system 10 can be configured to operate the one or more charging ports 14 as a Level 2 charger. In some examples, the charging system 10 can be configured to operate the one or more charging ports 14 as a Level 3 charger. In some examples, the charging system 10 can be configured to selectively operate the one or more charging ports 14 as either a Level 2 charger or a Level 3 charger. In some examples, the one or more charging ports 14 can include at least two charging ports and the charging system 10 can be configured to operate one or more of the charging ports as a Level 2 charger and the other charging ports as a Level 3 charger.

In some implementations, the charging system 10 can be configured to power one or more auxiliary components (not shown) of the charging system 10. In some examples, the charging system 10 can be configured such that one or more auxiliary components of the charging system 10 are powered by the power output 16 of the prime mover 12 simultaneously with the one or more charging ports 14. In other examples, the charging system 10 can further include one or more additional power sources (not shown) that can be configured to power the one or more auxiliary components of the charging system 10 independent of the prime mover 12 and the one or more charging ports 14. For example, in some implementations, the charging system 10 can include one or more batteries that can power the one or more auxiliary components and can be recharged via power from the power output 16 of the prime mover 12 or via one or more additional power sources (e.g., one or more solar panels) of the charging system 10.

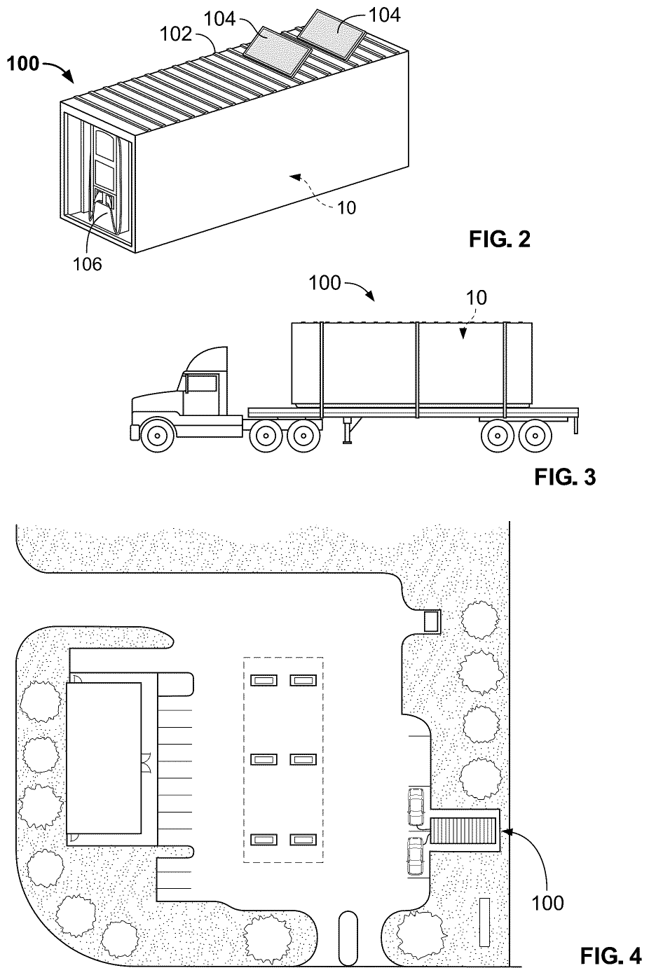

In some implementations, a charging system for charging one or more EVs, such as the charging system 10 illustrated in FIG. 1, can be part of a portable charging station that can be deployed to various locations regardless of availability of connection to an electrical grid. In this regard, FIG. 2 illustrates a portable charging station 100 according to examples of the present disclosure. The charging station 100 generally includes a charging system, such as the charging system 10 illustrated in FIG. 1, and a main housing 102 for housing a power source, e.g., the prime mover 12 of the charging system 10. In some examples, the charging station 100 may further include one or more additional power sources, such as a solar panel or panels 104, in addition to the prime mover 12, which will be discussed in further detail below. The charging station 100 has one or more charging dispensers or electric vehicle supply equipment (EVSE) 106 for charging an EV. As a particular example, the one or more charging ports 106 could be supplied by Ingeteam Corp. S.A., a manufacturer and distributor of such equipment.

The portable charging station 100 is configured such that the charging station 100 is capable of being transported to and deployed at any location as necessary. As demonstrated in FIG. 3, the charging station 100 can be loaded onto a trailer, e.g., a flatbed trailer, and delivered to a location, and as demonstrated in FIG. 4, the unloaded charging station 100 can, for example, charge a pair of EVs at a gas station. It is important to note that the charging station 100, and in particular the charging system 10, is configured such that the charging station 100 does not require any connection to an electrical power source and can operate independently thereof. Thus, the charging station 100 can be located anywhere desired, since the charging system 10 of the charging station 100 does not require external power and does not require being connected to the electrical grid. For example, the charging station 100 could be deployed to a gas station, a truck stop, a welcome center, a nature park, or a rest stop. As another example, the charging station 100 could be deployed for industrial purposes, e.g., to charge a fleet of EVs or a truck yard. In some examples, the charging station 100 can be configured to transportable by being towed by a transport vehicle. For example, in some implementations, the charging station 100 can include a permanently affixed trailer system, e.g., with two or more wheels and a trailer hitch, such that the charging station 100 can be towed directly to a location without having to be loaded into a cargo area of a transport vehicle (e.g., the flatbed truck of FIG. 3). If necessary, the charging station 100 can be picked up and moved to another site, without having to disconnect the charging station 100 from the electrical grid.

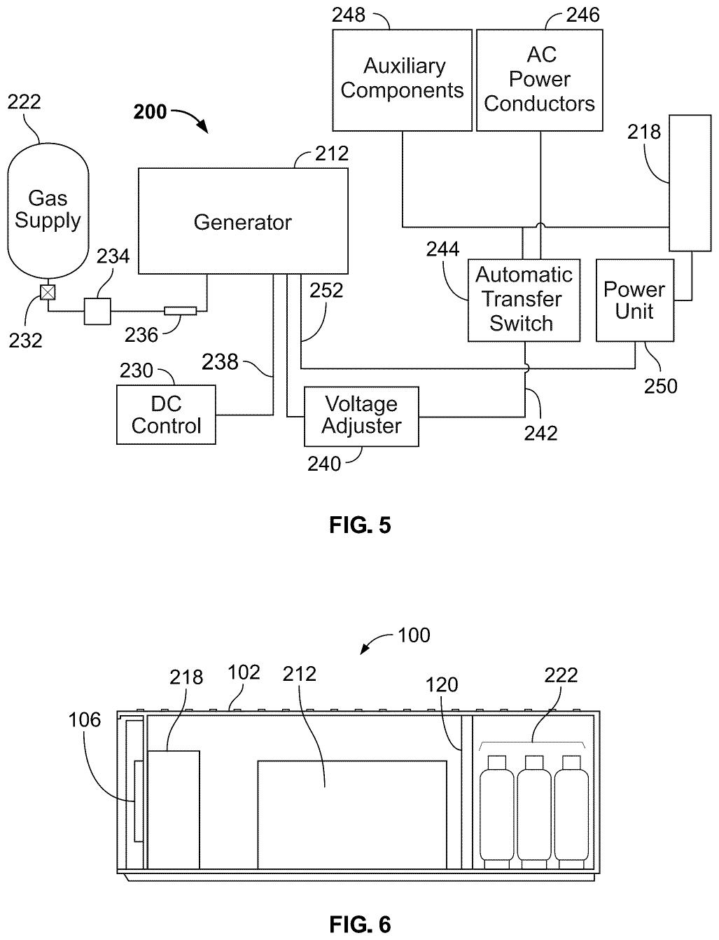

It should be appreciated that a charging station with charging system can be configured in various ways to provide the benefits described above. In this regard, FIG. 5 illustrates another exemplary charging system 200 for charging one or more EVs that can be included in a charging station, such as the charging station 100 illustrated in FIGS. 2-4. The charging system of FIG. 5 is similar in some ways to the charging system 10 illustrated in FIG. 1. To that end, features of the charging system 200 described below include reference numbers that are generally similar to those used in FIG. 1. For example, the charging system 200 includes a prime mover or generator 212 and a charging dispenser 218, just as the charging system 10 includes the prime mover 12 and the charging dispenser 18.

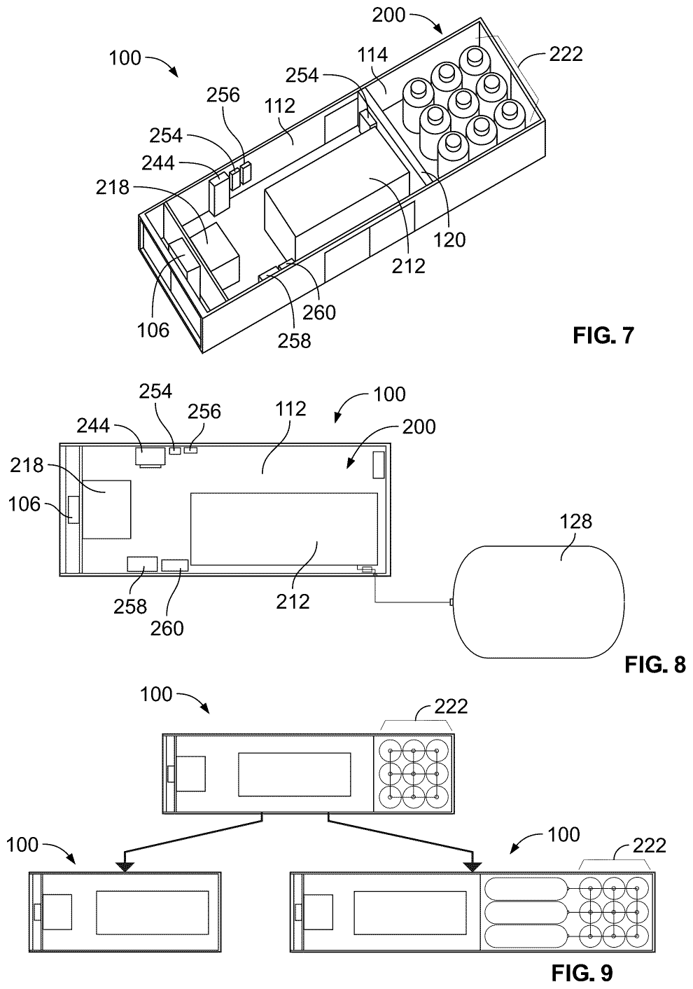

In the illustrated example of FIG. 5, the charging system 200 includes a fuel supply, e.g., a gas supply 222, that is connected to the prime mover, or generator 212. The gas supply 222 is preferably a standard gas tank, such as, a twenty-two pound (lb.) or one-hundred lb. tank, or any other portable sized gas tank. In some examples, the gas supply 222 may be located internally (FIG. 7) or externally (FIG. 8) of the main housing 102 of the charging station 100. In the illustrated example, the gas supply 222 is fluidly connected to the generator 212 via hose or pipe, preferably flexible hose or pipe 230. In some cases, one or more components, such as, e.g., a valve 232, a regulator 234, among others, can be disposed between the gas supply 222 and the generator 212 to control and/or monitor flow of gas to the generator 212. The gas supply 222 is preferably renewable natural gas (RNG) (e.g., supplied via a gas supply pipeline connection) or compressed natural gas (CNG), with the fuels being interchangeable for the charging station 100, and the generator 212 is preferably a commercially available generator, such as an A/C generator or a D/C generator.

Still referring to FIG. 5, in the illustrated example, the generator 212 is connected to a D/C control 236 by way of D/C control wires 238. It should be understood that not all of the inputs/outputs (I/O) on the generator 212 need to be D/C configurable, and, in some cases, the generator 212 could also be considered as incorporating I/O features for directly connecting and interfacing with other components of the charging station 100. For example, in some implementations, the generator 212 may interface or be directly in communication with other controls, such as, as a controller (not shown), within the charging station 100.

With continued reference to FIG. 5, in the illustrated example, the generator 212 is also connected to a voltage adjuster 240, e.g., a 480 volt (V) to 120 V transformer. In the illustrated example, the voltage adjuster 240 is connected to alternating current (A/C) power wires 242 that are connected to an automatic transfer switch 244. Preferably, the A/C power wires 242 are 120/240 VAC. The automatic transfer switch 244 is further connected to A/C power conductors 246 and auxiliary components 248, such as, e.g., lights, ventilation, security cameras, the internet or displays for the charging station 100, among others. In the illustrated example, the generator 212 is also connected to the A/C power conductors 246 that are subsequently connected to a power unit 250 by way of A/C wires 252.

In the illustrated example, the A/C power conductors 246 (e.g., 120/240 V) can provide an additional power source, such as, e.g., solar power from solar panels 104 (see FIG. 2), to power the auxiliary components 248 through the transfer switch 244 and independent of the generator 212. The generator 212, through the voltage adjuster 240 and the A/C power wires 242, also supplies 120/240 VAC to the transfer switch 244. The generator 212 connection with the power unit 250 is 480 V through A/C wires 252. In the illustrated example, the connections between the generator 212 and each of the transfer switch 244 and the power unit 250 are separate connections due to relatively high voltage levels. In some examples, the A/C power wires 252 may be 480 VAC.

Still referring to FIG. 5, in the illustrated example, the power unit 250 is connected to the charging dispenser 218 and supplies a D/C bus voltage (e.g., 920 VDC) to the charging dispenser 218 for charging one or more EVs that can be connected to the charging dispenser 218 via one or more charging ports (not shown). Further, the transfer switch 244 is configured to manage the 120 V components of the charging station 100 when the generator 212 is off and manages the power flow while changing the gas supply 222 to the charging station 100. Thus, the transfer switch 244 will manage the 120 VAC auxiliary power to the charging dispenser 218 when the generator 212 is on or off, as discussed above.

Referring now to FIGS. 6 and 7, FIG. 6 is a cutaway schematic side view of the charging station 100 with the charging system 200 illustrated in FIG. 5, and FIG. 7 is an overhead view of the charging station 100 with a top wall of the main housing 102 of the charging station 100 removed. In other words, FIGS. 6 and 7 demonstrate an exemplary arrangement of the charging station 100 illustrated in FIGS. 2-4 with the charging system 200 illustrated in FIG. 5. In particular, the charging dispenser 218 is connected to the power unit 250 which is connected to the generator 212, as discussed with respect to FIG. 5. In the illustrated example, the main housing 102 of the charging station 100 has a front or first housing section 112, which houses the power unit 250 and the generator 212, and a rear or second housing section 114, which houses the gas supply 222. The front housing section 112 can further house other electrical components of the charging station 100 or the charging system 200, as well. For example, in the illustrated implementation, the front housing section 112 of the main housing 102 also houses the transfer switch 244, one or more safety switches 254, a load center 256, a power cell 258, an inverter 260, and other electrical components for properly wiring and controlling the charging station 100 and the charging system 200.

A first wall or partition 120 separates the front housing section 112 from the rear housing section 114. As mentioned above, in the illustrated example, the rear housing section 114 houses the gas supply 222. As depicted in FIG. 7, in the illustrated example, a 3×3 array of gas tanks collectively form the gas supply 222. However, it should be appreciated that based on the amount of electricity produced by the charging station 100 or the size of the gas supply 222, i.e., corresponding to the size and quantity of the gas tanks, there may be more or fewer gas tanks included in the charging station 100 than those shown in FIG. 7.

In some examples, the charging station 100 of the present disclosure may also be designed alternatively or additionally with an external gas supply 222. For example, FIG. 8 illustrates an alternative configuration of the charging station 100 with an external gas supply 222, such as, e.g., an external gas tank 128. The ability to utilize the external tank 128 as the gas supply 222 allows for a larger gas supply 222 to be provided for the charging system 200 of the charging station 100. However, it is to be understood that the example arrangement of FIG. 8 would still not require connection to an electrical grid. Examples of various arrangements of the charging station 10 are shown in FIG. 9, including arrangements with external fuel supplies and arrangements with internal fuel supplies, and the charging ports 106 could be configured as Level 2 or Level 3 chargers. As noted above, charging stations 100 with an internal gas supply 222 could have differing number of gas tanks within the main housing 102, with more gas tanks being directed towards higher charging capacity for the charging station 100 overall.

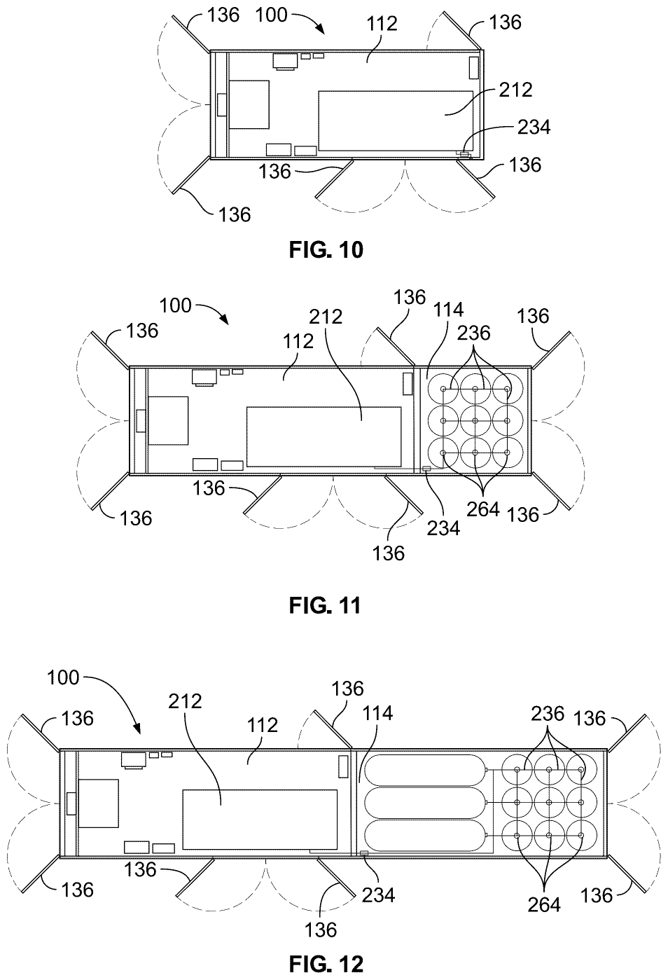

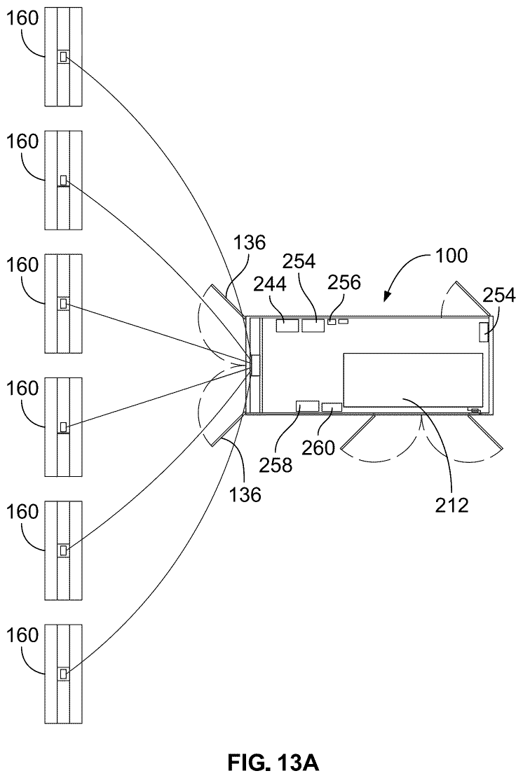

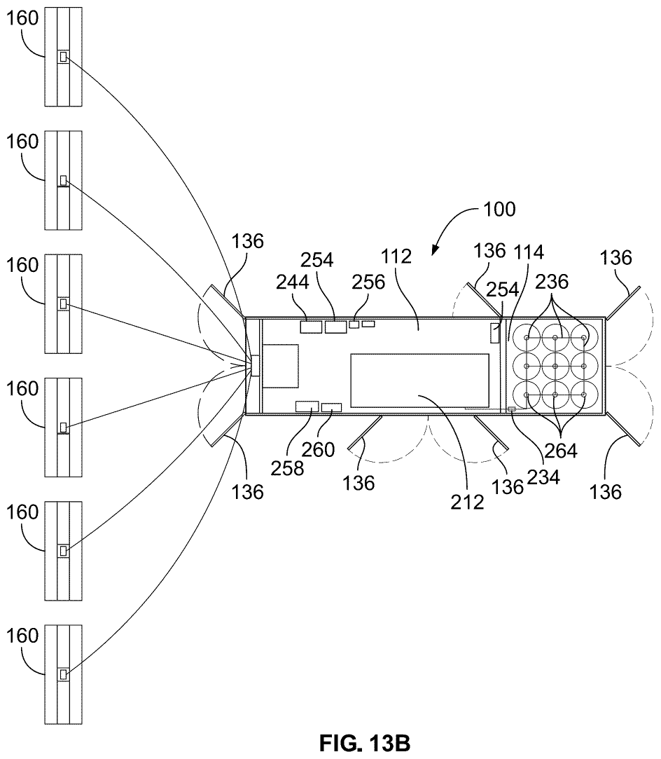

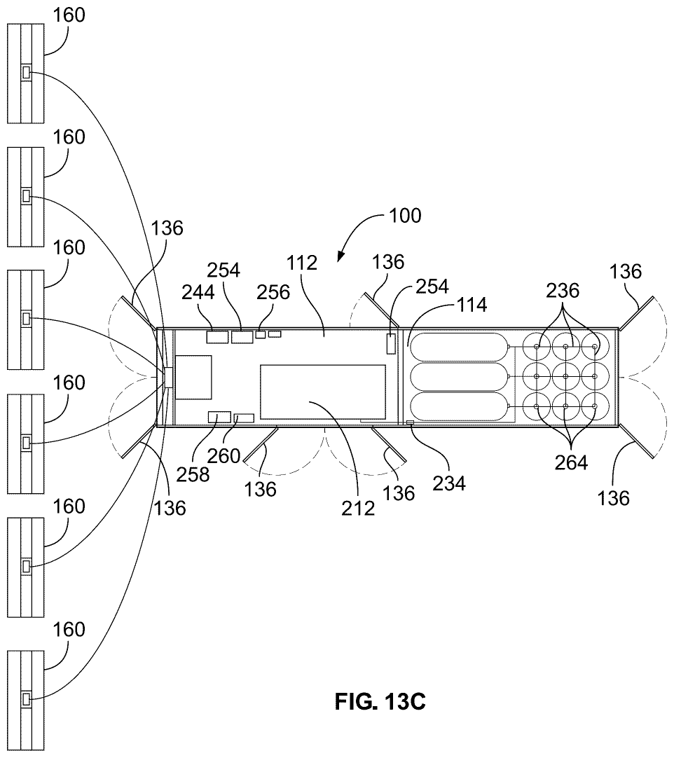

FIGS. 10-12 provide overhead views of the designs depicted in FIG. 9. Depending on the use, location, or the anticipated number of EVs that will be charged or the time it might take to replace the gas supply 222, the dimensions of the charging station 100 can vary. For example, the charging stations 100 depicted may have varying lengths, such as, e.g., 20 feet (ft.) (FIG. 10, gas supply shown in FIG. 8), 30 ft. (FIG. 11), or 40 ft. (FIG. 12). Each of the alternative designs of the charging station 100 shown in FIGS. 9-12 generally have the same layout, with each of the charging stations 100 having the generator 212 arranged as discussed above, with the additional lengths providing for more storage of the gas supply 222, and more or less fuel capacity. For example, an arrangement as in FIG. 11 may be able to have a gas supply equivalent to 297 GGE (e.g., nine 33 GG tanks), while the arrangement of FIG. 12 may provide substantially more capacity, e.g., 200%. Each of the example arrangements of the main housing 102 of the charging station 100 has one or more doors 136 for accessing the front housing section 112 or the rear housing section 114. The one or more doors 136 may also be used to enclose the charging ports 106 when not in use or the doors 136 may protect the charging station 100 when the charging station 100 is being transported (see FIG. 3).

Still referring to FIGS. 10-12, the charging stations 100 are connected to the gas supply 222 with the regulator 234 and the use of hose 236. A typical quick connect 264 may be used for easy connection of the gas supply 222 to the hose 236, with further hose 236 being used to connect the various tanks of the gas supply 222 together (see FIGS. 11 and 12). Each of the exemplary arrangements illustrated in FIGS. 9-12 provides for a portable charging station 100 that is capable of operating independently from an electrical power grid.

It should be appreciated that a portable charging station of the present disclosure can be of varying sizes and capabilities. One example would be the charging station 100 configured as a Level 3 EV charger capable of charging at 150 KW with a fuel supply 222 including individual gas tanks having a capacity of 297 GGE. It is preferred that the total full load runtime of such charging station 100 is at least 18 hours. However, as described herein, the total full load runtime of the charging station 100 could be increased with modifications to the power cell 258, generator 212, or the gas supply 222.

FIGS. 13A-13C show diagrams of the exemplary charging stations 100 of FIGS. 10-12 being used to provide electricity to a plurality of individual charging hubs 160. As an example, any of the charging stations 100 in various combinations may operate as a 150 KW charging station, with the individual charging hubs 160 being configured as Level 2 chargers or Level 3 chargers, or a combination thereof. It should be understood that the charging station of the present disclosure may be able to deliver more or less power generation, as needed. It should also be understood that the charging stations of the present disclosure can support both types of Level 2 or Level 3 chargers, either alone or in combination.

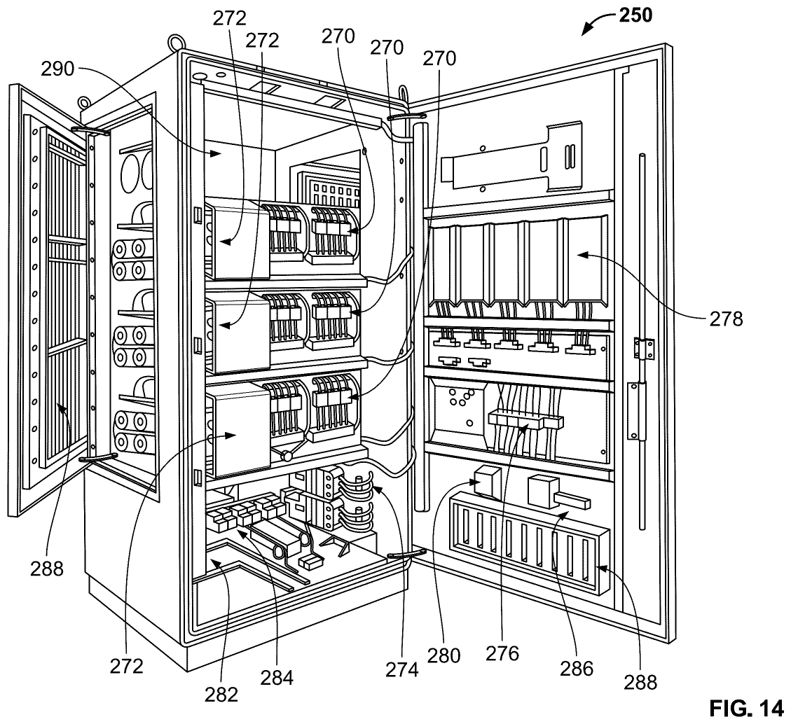

FIG. 14 shows a perspective view of an exemplary power unit 250 of the charging system 200 (see FIG. 5) with a door thereof opened, as can be included in a charging station of the present disclosure. As depicted, the power unit 250 is configured to provide power for a 150 KW charging station. The power unit 250 has a plurality of individual power modules 270 that form the basis of the power unit 250. As one particular example, the power modules 270 each can be 50 kW power modules. Each of the power modules 270 are connected to a respective output contactor 272. The power modules 270 are generally controlled by a controller 274, which is in electrical communication to the power modules 270 with safety relays 276 for relaying power from power supplies 278, 280. As one particular example, the power supply 278 can be a 24 VDC power supply and the power supply 280 can be a 12 VDC power supply. The power unit 250 further has an output section 282 and an input section 284 for connecting and communicating the power unit 250 with the other components of the charging system 200 and the charging station 100. The input section 284 is connected to the 480 VAC from the generator 212, and the output section 282 connects the 920 VDC bus to the charging dispenser 218. An optical transceiver 286 further assists in the communication of the power unit 250 with other aspects of the charging station 100, such as the auxiliary devices described above.

As shown further in FIG. 14, the power unit 250 may also have one or more vents 288 for allowing ambient air to circulate through the power unit 250. For example, heat generated during operation of the power unit 250 can be dissipated away from the power unit 250 through the vents 288.

As one particular example, the power unit 250 can be a 150 kW power unit. However, it is to be understood that the power unit 250 may be configured to have a higher or lower power capacity. In this regard, the power unit 250 may be configured such that the power capacity of the power unit 250 can be increased or decreased based on a number of the power modules 250 included. In particular, each of the power modules 270 is capable of being removed and reinserted into the power unit 250, and the power unit 250 can be designed with further open areas 290 that would allow for additional power modules 270 to be added to the power unit 250. Thus, an additional power module 270 could be added to the power unit 250 to increase the charging capacity of the power unit 250. For example, another 50 kW power module 270 could be added to the power unit 250, thereby increasing the charging capacity of the power unit 250 from 150 KW to 200 kW. It is to be further understood that the power unit 250 may be arranged in a different fashion as shown in FIG. 14, which is merely exemplary of a power unit that can be used in a charging station according to aspects of the present disclosure.

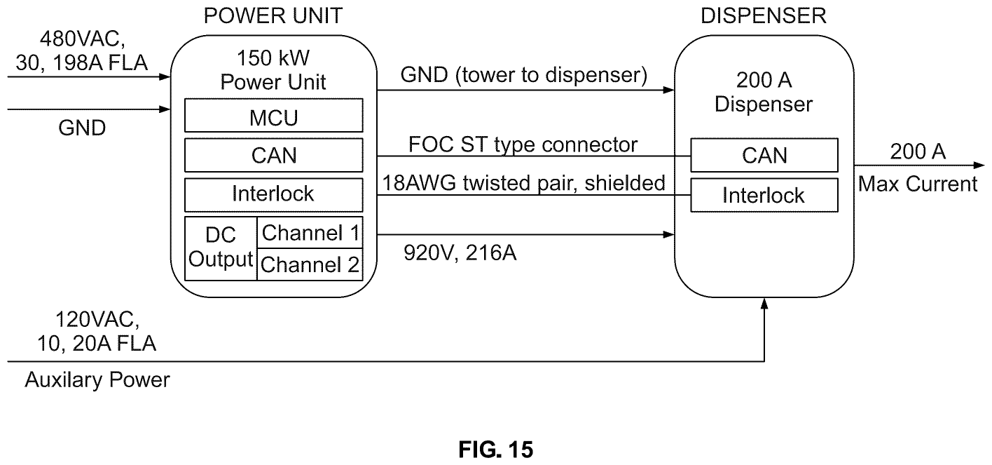

FIG. 15 provides another flowchart depicting an overview of the communication between the power unit 250 and the charging dispenser 218. In the illustrated example, the wires used for the power unit 250 are high voltage wirings, which requires sufficient protection for the wires. Such wirings can be particularly beneficial since the charging station 100 is portable and the wiring is not buried in the ground, which minimizes extra precaution that must be taken to insure safety for conventional charging stations that are connected to an electrical grid. Also, it is to be understood that a common ground is required through the charging station 100, e.g., to prevent shock to a user when charging an EV.

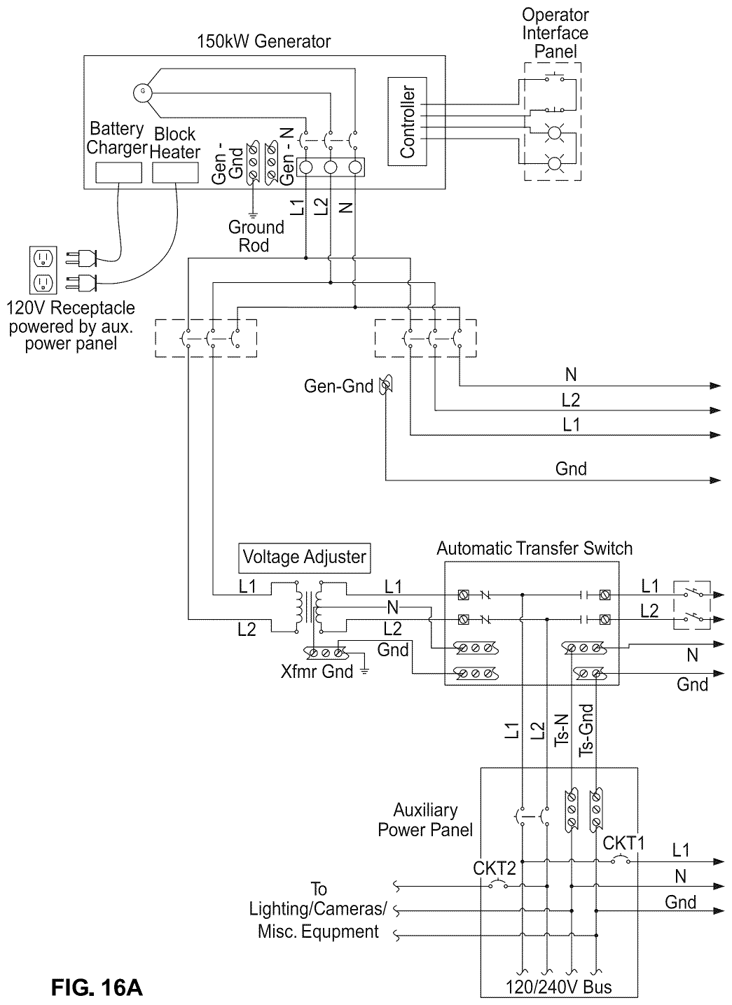

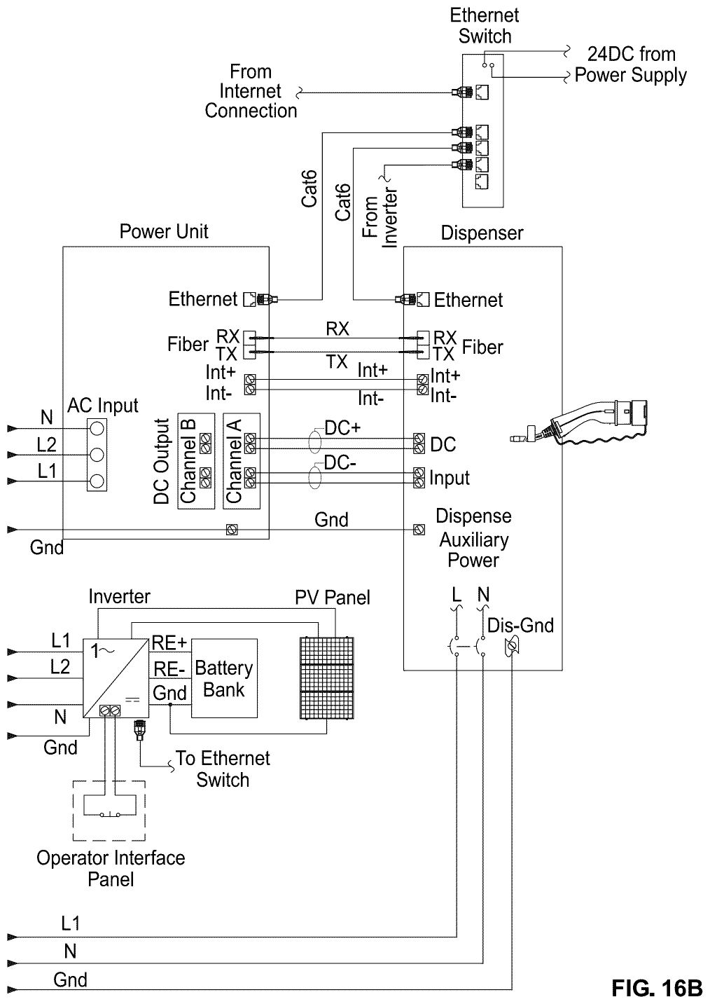

Further details of electrical connections of the charging system 200 of the charging station 100 are shown in FIGS. 16A and 16B, which illustrate a particular arrangement of the schematic diagram of the charging system 200 shown in FIG. 5. The wiring as depicted could support a Level 3 charging station. As with all of the examples disclosed herein, it should be understood that the arrangement shown in FIGS. 16A and 16B are one of several example implementations that would fall within the scope of the present disclosure and should not be considered limiting.

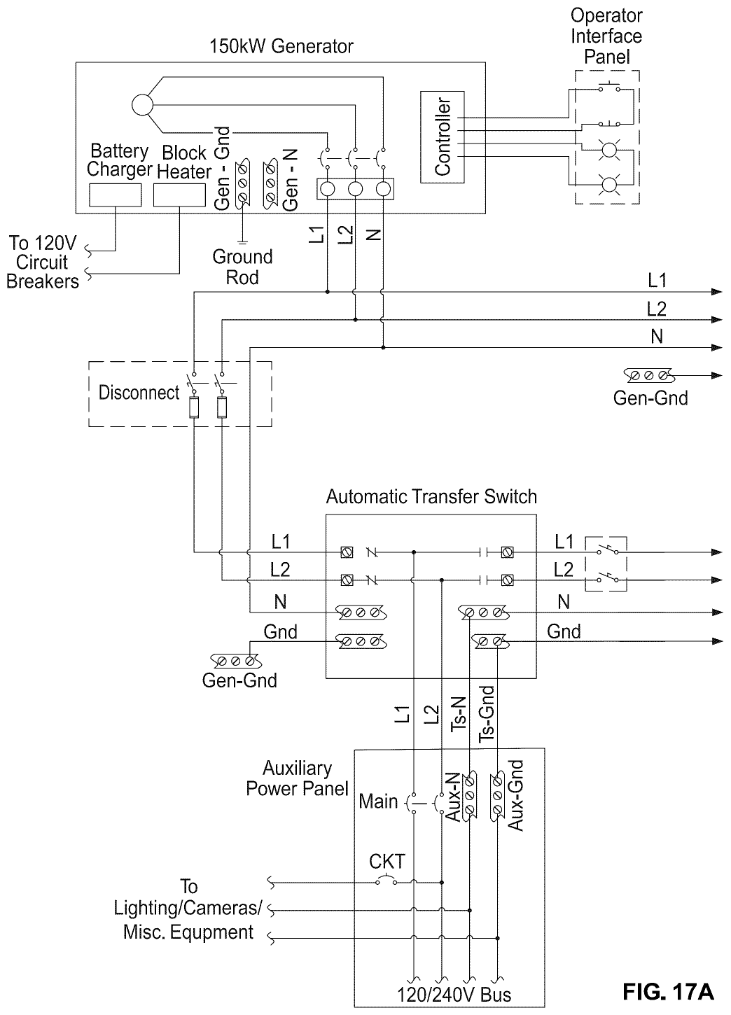

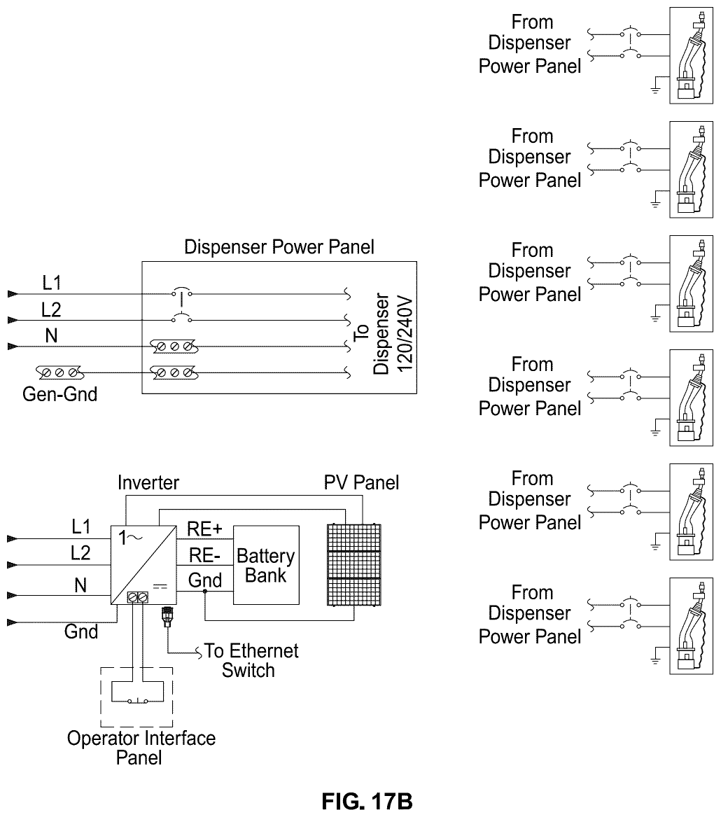

An alternative arrangement of the electrical connections of the charging system 200 illustrated in FIGS. 16A and 16B is depicted in FIGS. 17A and 17B, which could also be incorporated into the schematic diagram of FIG. 5. The particular exemplary arrangement shown in FIGS. 17A and 17B could be an example of a Level 2 charging station.

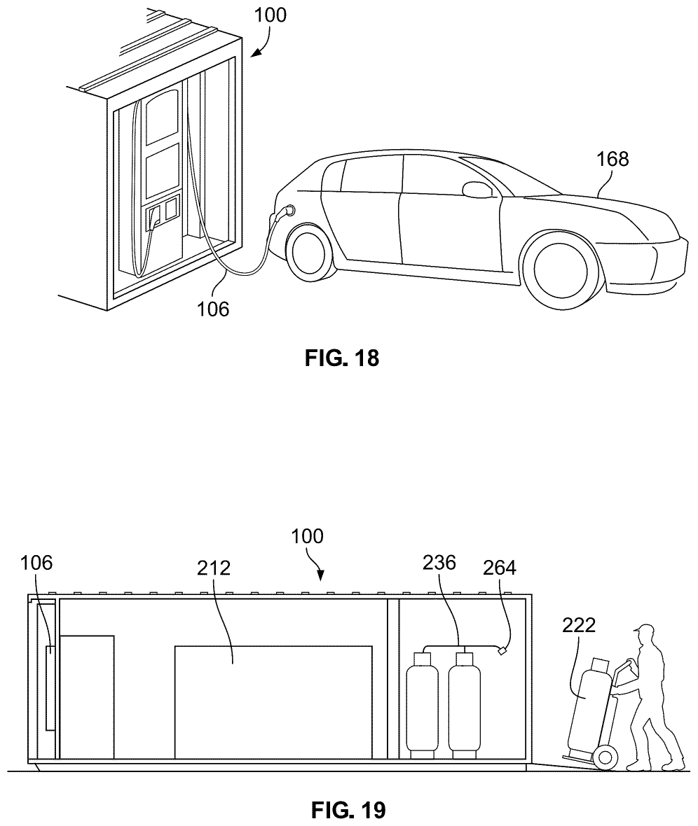

The resultant charging station 100 of the present disclosure in one of various example configurations and arrangement is shown in FIG. 18, carrying out its intended use of recharging an EV 168. As discussed above, this can be carried out in any of a variety of locations as the charging station 100 does not require a connection to an electrical grid.

FIG. 19 demonstrates further utility of a portable charging station, such as any of the charging stations 100 of FIGS. 2-18, in accordance with the present disclosure. As depicted, at least a portion of the gas supply 222 of the charging station 100 can be replenished as necessary, with a delivery person providing one or more new gas tanks when one or more of the gas tanks from the gas supply 222 is emptied. This particular arrangement can provide for continuous operation of the charging station 100, regardless of whether or not an electrical grid in the area of operation is functional or not.

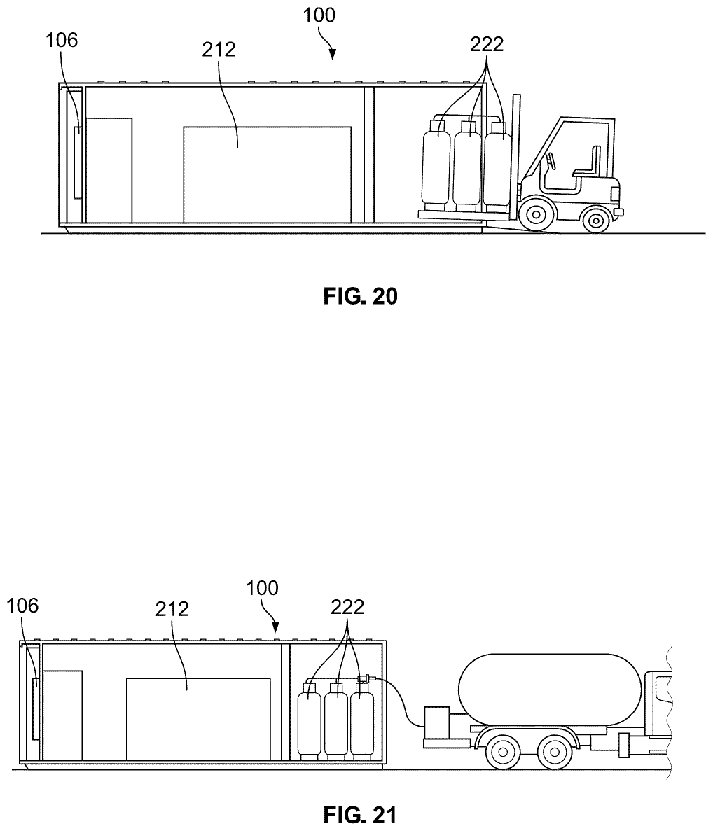

In some examples, the charging station 100 may also allow for a complete replacement of the gas supply 222, as shown in FIG. 20. In the illustrated example, the gas supply 222 is preferably positioned upon a pallet, with the entire gas supply 222 being disconnected from the charging station 100 and removed with the use of a forklift. A replacement gas supply 222 can then be inserted into the charging station 100 and connected to the charging system 200 relatively quickly and easily.

FIG. 21 shows the gas supply 222 of the charging station 100 being refilled directly on site. In particular, a delivery truck can be brought to the site and each of the tanks of the gas supply 222 can be refilled without needing to be removed from the charging station 100.

FIGS. 19-21 demonstrate the adaptability and flexibility of the disclosed technology so that the charging station 100 can be operated without requiring connection to an electrical grid. As such, a charging station in accordance with the present disclosure provides a unique design that can be employed at various sites to meet the growing need of charging stations for EVs.

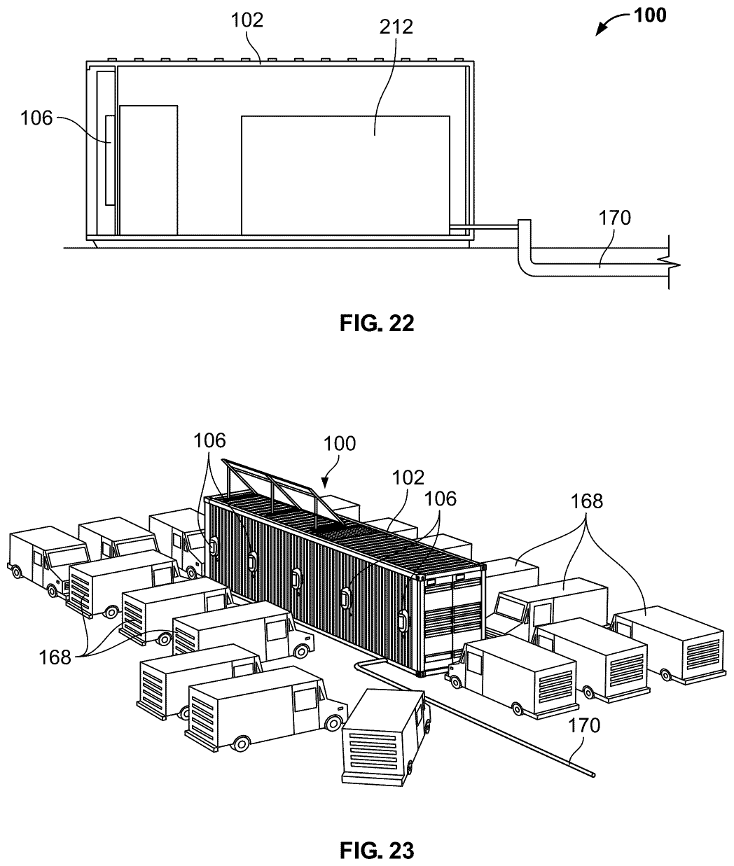

As briefly discussed above, in some cases, to provide a significantly large (or continuous) fuel supply for a charging system of a charging station so as to provide uninterrupted operation of the charging station during continued demand and to reduce an overall operating cost of the operating station. For example, as shown in FIG. 22, the generator 212 of the charging system 200 of the charging station 100 can be configured to directly connect to an existing fuel supply pipeline 170 (e.g., via an existing or new service line or lateral line leading from a larger pipeline). In some such examples, the generator 212 can be configured to operate with natural gas that is supplied directly from the fuel supply pipeline 170.

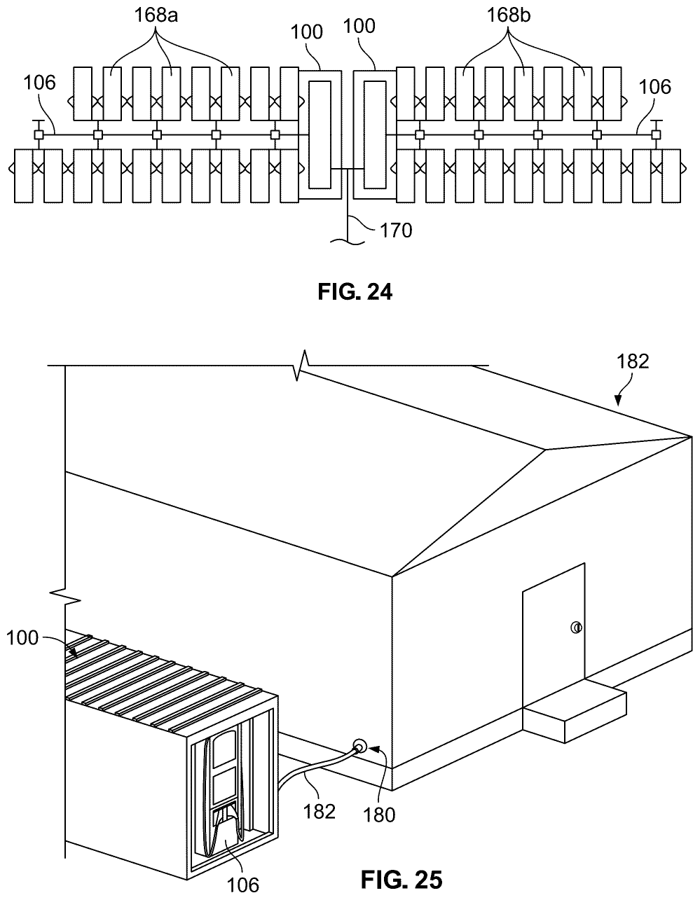

A charging station with a fuel supply that includes a fuel pipeline can also provide increased capability of the charging station or a system of charging stations to charge a significant number of EVs. For example, as shown in FIG. 23, the charging station 100 can be configured to operate with greater charging capacity such that the plurality of charging ports 106 can be disposed along a length of the main housing 102 of the charging station 100 and thus more EVs 168 can surround the exterior of the main housing 102 while charging. Further, as shown in FIG. 24, in some cases, two or more charging stations 100 can be disposed adjacent to one another and each connected to the fuel supply pipeline 170 such that a first plurality of EVs 168a can be charged by one of the charging stations 100 while a second plurality of EVs 168b can be charged simultaneously by the other charging station 100.

In some implementations, a charging station can be configured to provide power to an electrical power system that is external to the charging station in addition to being capable of charging one or more EVs. For example, as shown in FIG. 25, the charging station 100 can be configured to electrically connect with an external power system 180, e.g., via an external power cable 182, to provide power to the external power system 180. In some cases, the external power system 180 can be part of a house 182, as illustrated in FIG. 25. In other examples, an external power system 180 can be part of a mobile home, or the like. In either case, the charging station 100 can provide power to the external power system 180 separate from the charging ports 106 of the charging dispenser 218 or in parallel with the charging dispenser 218. In other words, in some cases, the charging station 100 can simultaneously power one or more external power systems 180 and charge one or more EVs that are connected to the charging ports 106.

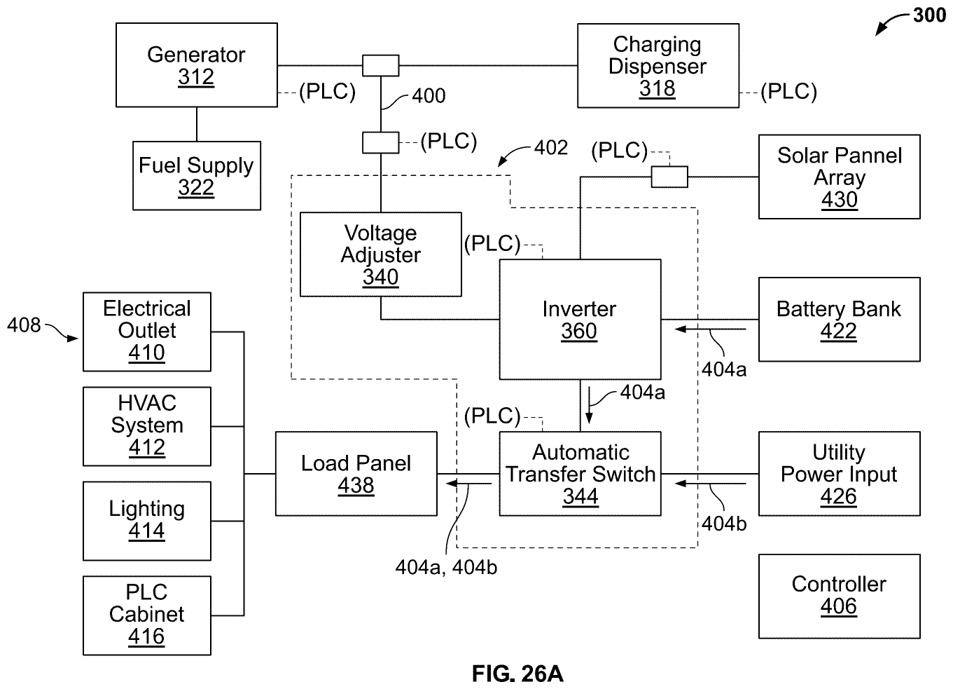

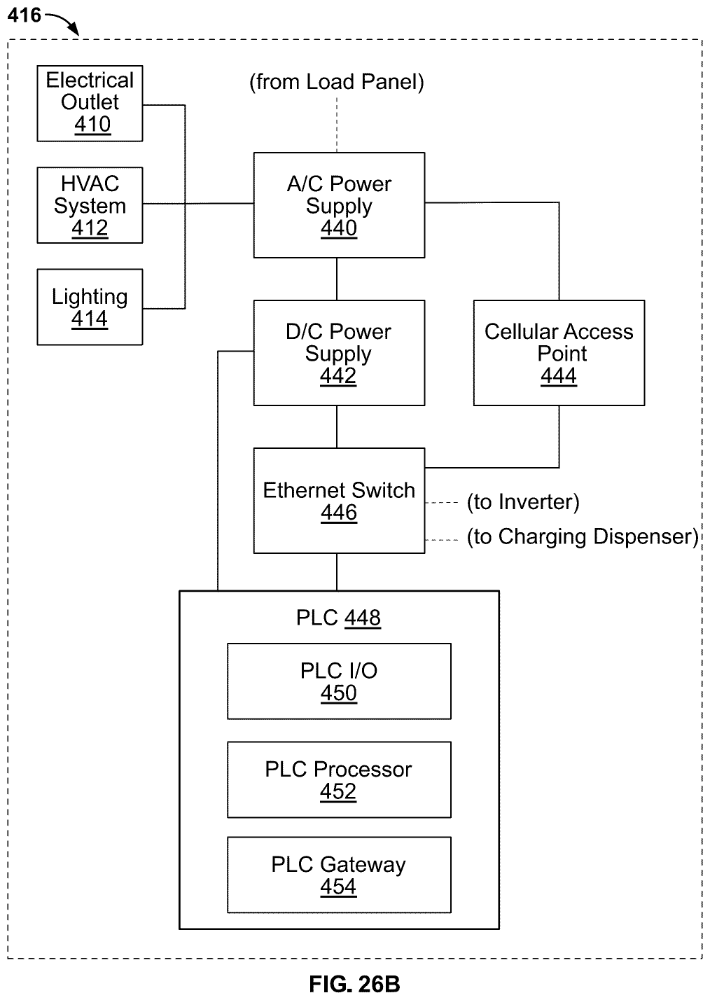

It should be appreciated that a charging system of a charging station can be configured differently than those illustrated in FIGS. 15, 16A, 16B, 17A, and 17B. In this regard, FIGS. 26A and 26B illustrate another example charging system 300 of a charging station, such as any of the charging stations 100 illustrated in FIGS. 2-14. The charging system 300 illustrated in FIGS. 26A and 26B is similar in some ways to the charging systems 10, 200 illustrated in FIGS. 1 and 5, respectively. To that end, features of the charging system 300 described below include reference numbers that are generally similar to those used in FIGS. 1 and 5. For example, the charging system 300 includes a generator 312, a charging dispenser 318, and a fuel supply 322 just as the charging systems 10, 200 include the prime movers 12, 212, the charging dispensers 18, 218, and the fuel supplies 12, 222, respectively.

Referring specifically to FIG. 26A, the charging dispenser 318 is in electrical connection with the generator 312 and the charging system 300 further includes an auxiliary power circuit 400 with a power conductor 402 (indicated as a dashed box in FIG. 26A) that is also in electrical connection with the generator 312 and a controller 406. In the illustrated example, the charging dispenser 318 and the auxiliary power circuit 400 are each connected to the generator 312 in parallel. The auxiliary power circuit 400 provides power to one or more auxiliary components 408 of the charging system 300, such as, e.g., an electrical outlet 410 (e.g., a 120 V outlet), a heating, ventilation, and air conditioning (HVAC) system 412, lighting 414, and a PLC cabinet 416. Other examples of auxiliary components 408 include a thermostat, a humidistat, or the like. The controller 406 is in electrical communication with each of the generator 312, the charging dispenser 318, and the power conductor 402 and can control one or more of the generator 312, the charging dispenser 318, and the power conductor 402 based on signals received from various components of the charging system 300, e.g., the charging dispenser 318.

In some examples, the generator 312 can be configured to operate with a prime running power rating and the A/C power output can be at least about 100 kW or at least about 180 kW. In some examples, the generator 312 can be configured to operate with a prime running power rating and the A/C power output can be about 100 KW to about 1,000 kW, about 100 KW to about 3,000 kW, about 180 kW to about 1,000 kW, or about 180 kW to about 3,000 kW.

With continued reference to FIG. 26A, the power conductor 402 of the auxiliary power circuit 400 is configured to provide a first circuit path 404a adapted for connection to a first additional power source, e.g., one or more batteries or battery bank 422, and a second circuit path 404b adapted for connection to a second additional power source, e.g., a utility power input 426 (i.e., an electrical connection to a power grid). As such, the power conductor 402 can be configured to selectively power the one or more auxiliary components 408 via one of: the generator 312, the first circuit path 404a, or the second circuit path 404b. In some examples, battery bank 422 may be external to the charging system 300.

The power conductor 402 of the auxiliary power circuit 404 can be configured in various ways to provide the first and second circuit paths 404a, 404b. In the illustrated example, the power conductor 402 includes a voltage adjuster 340, an automatic transfer switch 344, and an inverter 360. The transfer switch 344 is configured to be moveable between a first configuration, in which the one or more auxiliary components 408 are powered via the generator 312 or the first circuit path 404a, and a second configuration, in which the one or more auxiliary components 408 are powered via the second circuit path 404b. In some examples, with the transfer switch in the first configuration, the battery bank 422 can power the one or more auxiliary components 408 via the first circuit path 404a independent of the generator 312 and the utility power input 426, and, with the transfer switch in the second configuration, the utility power input 426 can power the one or more auxiliary components 408 via the second circuit path 404b independent of the generator 312 and the battery bank 422. As such, the charging system 300 is configured to operate without a connection to an electrical grid via the utility power input 426.

In some examples, the controller 406 can be configured to, e.g., based on signals received from at least the battery bank 422 and the utility power input 426, cause the transfer switch 344 to move between the first and second configurations. In some examples, the transfer switch 344 can be further configured to automatically move from the first configuration to the second configuration based on signals received from the battery bank 422.

In the illustrated example, a load panel 438 is arranged electrically between the transfer switch 344 of the power conductor 402 and the auxiliary components 408 and can distribute power to the auxiliary components 408 as well as other components, as shown in FIG. 26B. For example, referring to FIG. 26B, in the illustrated example, the A/C power supply 440 from the load panel 438 is distributed to the auxiliary components 408, e.g., the electrical outlet 410, the HVAC system 412, and the lighting 414, as well as to a cellular access point 444 and a D/C power supply 442. The cellular access point 444 is in communication with an ethernet switch 446 and can be configured to provide a cellular connection between the charging system 300 and an external communication system (not shown). The D/C power supply 442 is in communication with a PLC 448, which can include a PLC I/O 450, a PLC processor 452, and a PLC gateway 454. In some examples, the controller 406 (see FIG. 26A) can be included in the PLC 448. In other examples, the controller 406 can be in communication with at least the PLC processor 452 of the PLC 448.

The charging system 300 can further include a third additional power source that can recharge the battery bank 422. In the illustrated example, the third additional power source, e.g., a solar panel or a solar panel array 430, is in electrical connection with the battery bank 422 via the inverter 360 and can recharge the battery bank 422 independent of the generator 312 and the utility power input 426. In some examples, the third additional power source can be a portion of A/C power output from the generator 312.

The voltage adjuster 340 of the power conductor 402 is in disposed electrically between the generator 312 and the transfer switch 344 along the auxiliary power circuit 400. In particular, the voltage adjuster 340 is configured to modify the A/C power output from the generator 312 to an A/C power supply that is provided to the transfer switch 344 to power the one or more auxiliary components 408 when the transfer switch 344 is in the first configuration and the utility power input 426 is not connected to an electrical grid. In some examples, the voltage adjuster 340 can be a transformer that is configured to step down the A/C power output. In some such examples, the A/C power output from the generator 312 can be 480V and the A/C power supply from the transformer can be 240V. In some examples, the A/C power supply from the voltage adjuster 340 can be provided to the transfer switch 344 to power the one or more auxiliary components 408, e.g., when the transfer switch 344 is in the first configuration, or to the battery bank 422 to recharge the battery bank 422, e.g., when the transfer switch 344 is in the second configuration. In some examples, the voltage adjuster 340 is a switch convertor (with or without one or more rectifiers), such as, e.g., a buck converter, a boost converter, a Cuk converter, a synchronous converter, an inverter, or the like.

Referring still to FIG. 26A, the inverter 360 is in electrical connection with the voltage adjuster 340 and the transfer switch 344. As such, the inverter 360 can be configured to, with the transfer switch 344 in the first configuration, selectively power the one or more auxiliary components 408 via the A/C power supply from the voltage adjuster 340 or the battery bank 422 (i.e., the first circuit path 404a).

The charging dispenser 318 can be similar to the charging dispenser 218 of the charging system 200 illustrated in FIG. 5 but can further include components and functionality of the power unit 250 illustrated in FIG. 14. For example, in some implementations, the charging dispenser 318 can be a modular charging dispenser having a power dispensing capacity that is variably customizable. In one particular example, the modular charging dispenser 318 can include a charging dispenser input (not shown) that receives the A/C power output from the generator 312, a plurality of power modules 370 that each receive at least a portion of the A/C power output from the charging dispenser input, and a charging dispenser output (not shown) in electrical communication with each power module of the plurality of power modules 370 and is configured to provide at least a portion of the A/C power output of the plurality of power modules 370 to one or more charging ports 306 that are electrically connected to the charging dispenser output and are configured to electrically connect to at least one EV. Thus, similar to the power unit 250, the power dispensing capacity of the modular charging dispenser 318 can be variably customizable based on a number of power modules of the plurality of power modules 370 that are included in the charging dispenser 318.

In some examples, the power dispensing capacity of the charging dispenser 318 can be about 30 kilowatts (KW) to about 3,000 kW, inclusive, about 30 kW to about 1,000 kW, inclusive, or about 200 kW to about 600 kW, inclusive. In some cases, one or more of the power modules of the plurality of power modules 370 of the charging dispenser 318 can be configured to modify at least a portion of the A/C power output as a D/C power output that is provided to the at least one EV.

In some examples, the one or more charging ports 306 of the charging dispenser 318 can include at least two charging ports. In some such examples, the controller 406 can be further configured to, based on signals received from the charging dispenser 318, variably control the power output provided by each charging port of the at least two charging ports 306 via control of the plurality of power modules 370. Further, at least some of the plurality of power modules 370 can be configured to selectively modify the at least portion of the A/C power output as a D/C power output that is provided to an EV from one of the at least two charging ports 306.

In some examples, the one or more charging ports 306 of the charging dispenser 318 can include a first charging port and a second charging port, and the controller 406 can be configured to, based on signals received from the charging dispenser 318, operate the first and second charging ports as a Level 2 charger or a Level 3 charger. In some examples, the one or more charging ports 306 of the charging dispenser 318 can include at least three charging ports, and the controller 406 can be configured to, based on signals received from the charging dispenser 318, selectively operate each charging port of the at least three charging ports as a Level 2 charger or a Level 3 charger. In some examples, the one or more charging ports 306 of the charging dispenser 318 can include at least five charging ports, and the controller 406 can be configured to, based on signals received from the charging dispenser 318, operate each charging port of the at least five charging ports as a Level 2 charger.

Referring specifically to FIG. 26B, XXX

In some cases, it may be beneficial to provide the charging system 300 with boosted charging capabilities, e.g., during peak usage of the charging system. Thus, in some implementations, the charging system 300 can further include a fourth additional power source, e.g., one or more supplemental or booster batteries (not shown), that can be in electrical communication with the charging dispenser 318. In some such examples, the controller 406 can be configured to determine a present load of the charging dispenser 318 and control the one or more supplemental batteries based on the determined present load to provide a supplemental power output to the charging dispenser 318 in addition to the A/C power output from the generator 312. In some such examples, the at least one supplemental battery can be rechargeable via the solar panel array 430 or the generator 312.

In some examples, it may be beneficial for a charging system of a charging station to include two or more generators, e.g., to provide increased power output during peak charging usage of the charging station. For example, in some implementations, the charging system 300 can include a plurality of generators 312, and the controller 406 can be further configured to determine a present load of the charging dispenser 318 and control the plurality of generators 312 based on the determined present load of the charging dispenser 318.

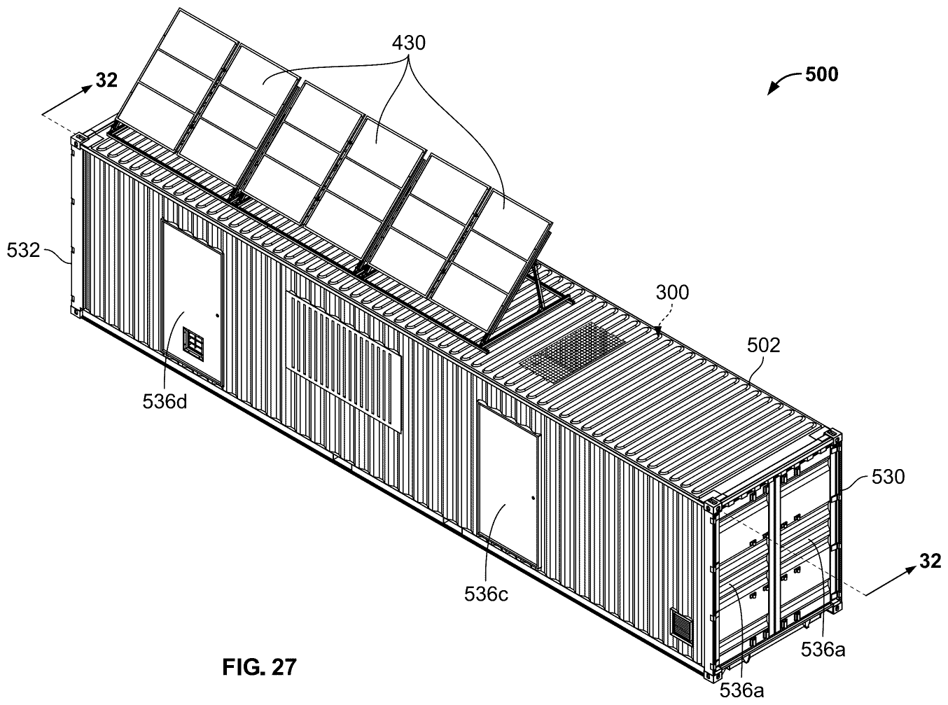

It should be appreciated that a charging station can have various arrangements. In this regard, FIGS. 27-32 illustrate another example portable charging station 500 that include the charging system 300 illustrated in FIGS. 26A and 26B. It should be appreciated that the charging station 500 could instead include charging system 100 illustrated in FIG. 1 or the charging station 200 illustrated in FIG. 5. The charging station 500 is similar in some ways to the charging station 100 of FIGS. 2-25. To that end, features of the charging station 500 described below include reference numbers that are generally similar to those used in FIGS. 2-25.

Referring specifically to FIGS. 27-29, the charging station 500 has a main housing 502 with a housing interior compartment 508 that houses the charging system 300. In the illustrated example, the main housing 502 is rectangular shaped and has a first end 530 and a second end 532 opposite the first end 530 that partially define the housing interior compartment 508. With the charging system 300 housed within the housing interior compartment 508 of the main housing 502, the sensitive electronic components of the charging system 300 can be shielded from exposure to outdoor surroundings, such as, moisture, dust, wind, and temperature. It should be appreciated that the main housing 502 can be formed to withstand prolonged exposure to an outdoor environment as well as contact with foreign objects when the charging station 500 is transported.

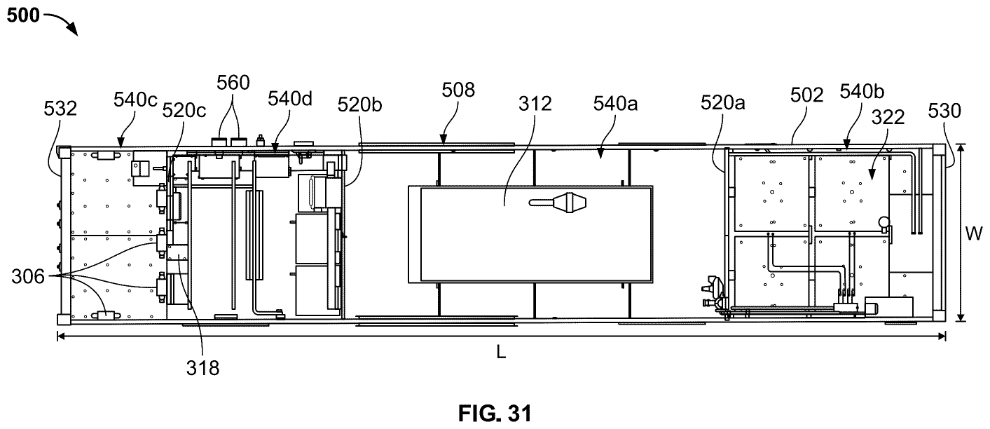

The main housing 502 can be sized to facilitate transportation of the charging station 500 between locations. For example, in some implementations, the main housing 502 can be configured to be transportable via a transport vehicle, such as, e.g., a flatbed truck as illustrated in FIG. 3. In some implementations, a length L (see FIG. 31) of the main housing 502 (i.e., a distance measured between the first and second ends 530, 532) can be less than about 100 feet (ft.). In some examples, the length L of the main housing 502 can be in a range of about 10 ft. to about 80 ft., inclusive, in a range of about 15 ft. to about 70 ft., inclusive, or in a range of about 20 ft. to about 53 ft., inclusive. In some examples, the length L of the main housing 502 can be 40 ft. Similarly, in some examples, a width W (see FIG. 31) of the main housing 502 can be less than about 20 ft. In some examples, the width W of the main housing 502 can be in a range of about 5 ft. to about 15 ft., inclusive, or in a range of about 8 ft. to about 10 ft., inclusive. In one particular example, the main housing 502 can be formed of a standard sized shipping container that is formed of corrugated metal sheets.

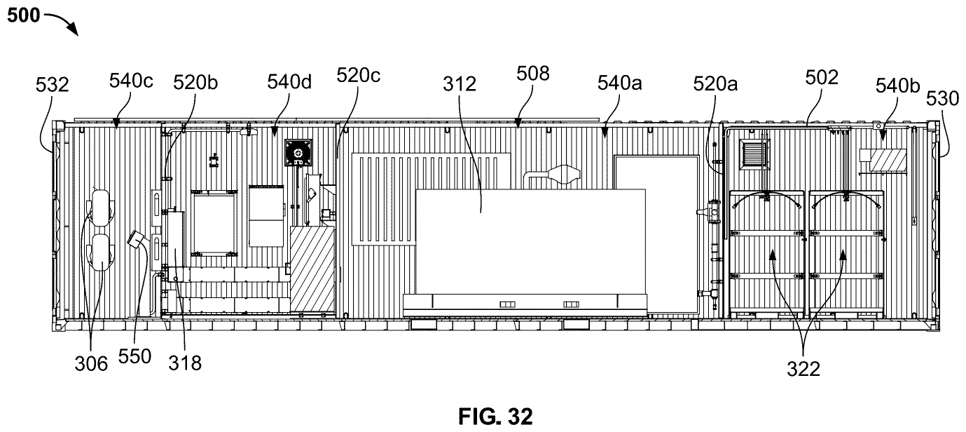

Referring specifically to FIGS. 31 and 32, the main housing 502 can further include one or more walls or partitions arranged within the housing interior compartment 508 that can define one or more sections or rooms of the housing interior compartment 508, in which particular components of the charging system 300 can be disposed. In the illustrated example, a first partition 520a is arranged within the housing interior compartment 508 nearest the first end 530 of the main housing 502, a second partition 520b is arranged within the housing interior compartment 508 between the second end 532 of the main housing 502 and the first partition 520a, and a third partition 520c is arranged within the housing interior compartment 508 nearest the second end 532 of the main housing 502 and adjacent to the second partition 520c. Thus, in the illustrated example, the housing interior compartment 508 includes a first housing section 540a, a second housing section 540b, a third housing section 540c, and a fourth housing section 540d that are at least partially separated from one another by one or more of the partitions 520a, 520b, 520c. In particular, the first housing section 540a is defined by the first and second partitions 520a, 520b and is disposed between the second and third housing sections 540b, 540c, the second housing section 540b is defined by the first partition 520a and the first end 530 of the main housing 502 (e.g., a first door 536a that at least partly defines the first end 530) and is disposed nearest the first end 530 adjacent to the first housing section 540a, the third housing section 540c is defined by the third partition 520c and the second end 532 of the main housing 502 (e.g., a second door 536b that at least partly defines the second end 532) and is disposed nearest the second end 532 and adjacent to the fourth housing section 540c, and the fourth housing section 540d is defined by the second and third partitions 520a, 520b and is disposed between the first and third housing sections 540a, 540c.

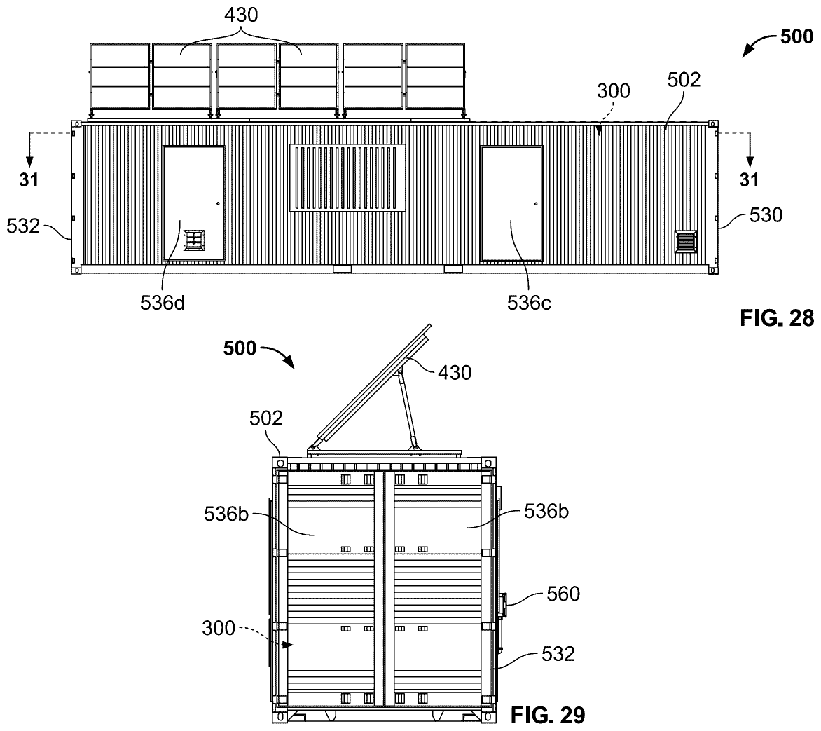

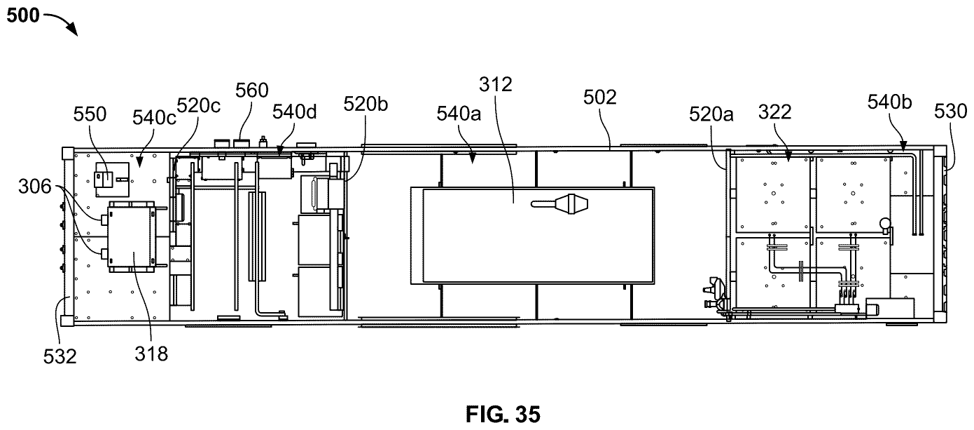

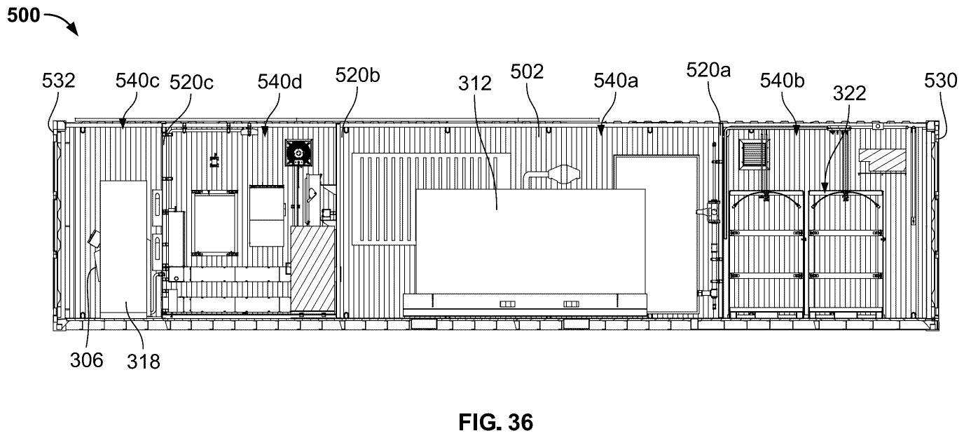

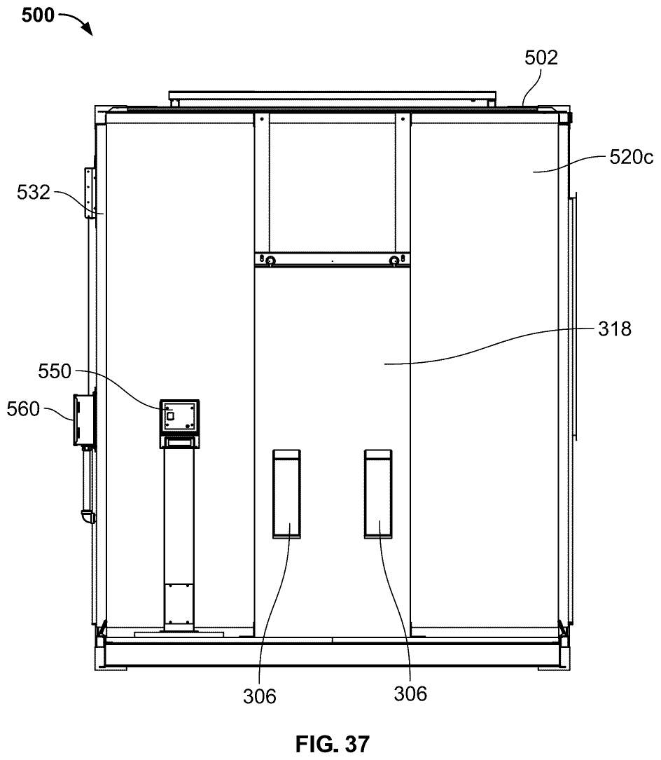

As briefly mentioned above, various components of the charging system 300 can be arranged within particular housing sections 540a, 540b, 540c, 540d and separated from other such components. With continued reference to FIGS. 31 and 32, in the illustrated example, the generator 312 is arranged within the first housing section 540a, the fuel supply 322 is arranged within the second housing section 540b, the plurality of charging ports 306 is arranged within the third housing section 540c, and the auxiliary components 408 and the charging dispenser 318 are arranged within the fourth housing section 540d. Furthermore, in the illustrated example, the first housing section 540a (and the generator 312 therein) is accessible to a user via a third door 536c (see FIGS. 27 and 28) of the main housing 502, the second housing section 540b (and the fuel supply 322 therein) is accessible via the first door 536a at the first end 530 of the main housing 502, the third housing section 540c (and the plurality of charging ports 306 therein) is accessible via the second door 526b at the second end 532 of the main housing 502, and the fourth housing section 540d (and the auxiliary components 408 and the charging dispenser 318 therein) is accessible via a fourth door 536d (see FIGS. 27 and 28) of the main housing 502. In some examples, the charging dispenser 318 can be arranged within the fourth housing section 540d with the plurality of charging ports 306 (e.g., as illustrated in FIGS. 35-37). This particular arrangement and separation of the components of the charging system 300 can be beneficial to maintain different temperatures and humidity in each of the housing sections 540a, 540b, 540c, 540d that can maintain the particular components of the charging system 300.

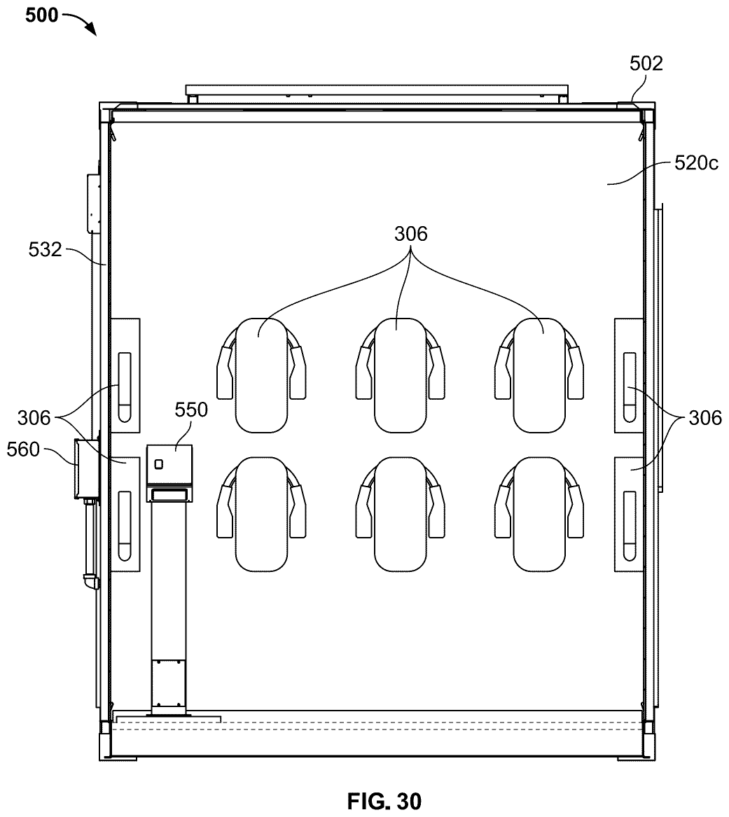

Referring specifically to FIG. 30, the plurality of charging ports 306 (i.e., the third housing section 540c) is accessible to a user from an exterior of the main housing 502 when the second door 536b is opened or removed. Thus, the second door 536b can be utilized to protect the plurality of charging ports 306 during transport of the charging station 500 and can prevent unwanted access to the plurality of charging ports 306. Further, the charging station 500 can further include a user interface 550 that can be disposed within the third housing section 540c. In some examples, the user interface 550 can be utilized by a user to operate the charging station 500 and to utilize one or more of the charging ports 306. For example, in some implementations, the user interface 550 can be configured to receive user information from a user of the charging station 500 that can correspond to payment for charging of an EV by the user. In some examples, the user interface 550 can be configured to receive user information via one or more various means, such as, e.g., a radio frequency identification (RFID) (e.g., via an RFID transmitter), a credit card swipe or tap, a near field communication (NFC) (e.g., via a mobile electronic device, such as, Apple Pay® or Google Pay®), Wi-Fi, or Bluetooth®.

Moreover, the charging station 500 can further include one or more exterior junction boxes 560 along an exterior of the main housing 502. In some examples, the one or more junction boxes 560 can include the utility power input 426 of the charging system 300 (see FIG. 26A) and/or a connection point for an external power system, e.g., the external power system 180 of FIG. 25, to be powered by the charging station 500. In some examples, one or more of the junction boxes 560 can be configured to connect to the solar panel array 430.

In the illustrated example of FIG. 30, the charging system 300 of the charging station 500 is configured to operate each of the plurality of charging ports 306 of the charging dispenser 318 as Level 2 chargers. In the illustrated example, the plurality of charging ports 306 includes ten charging ports. In some examples, the plurality of charging ports 306 can include more or less than ten charging ports. For example, in some implementations, the plurality of charging ports 306 can include two, three, or five or more charging ports. In some examples, the plurality of charging ports 306 can include between ten and twenty charging ports, inclusive. In some examples, some of the plurality of charging ports 306 can be arranged outside of the third housing section 540c. For example, in some implementations, one or more of the plurality of charging ports 306 can be arranged along an exterior of the main housing 502 (such as, e.g., the charging station 100 illustrated in FIG. 23). In some examples, one or more of the plurality of charging ports 306 can be arranged in second housing section 540b of the housing interior compartment 508 and accessible to a user via the first door 536a (see FIG. 27).

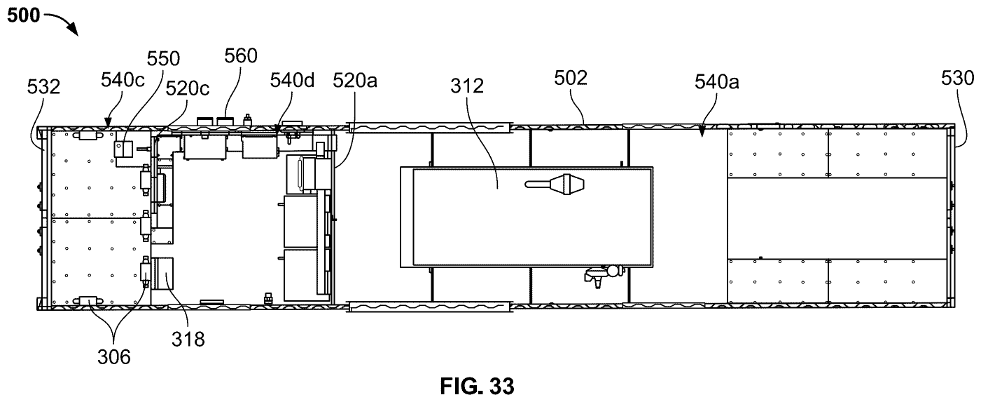

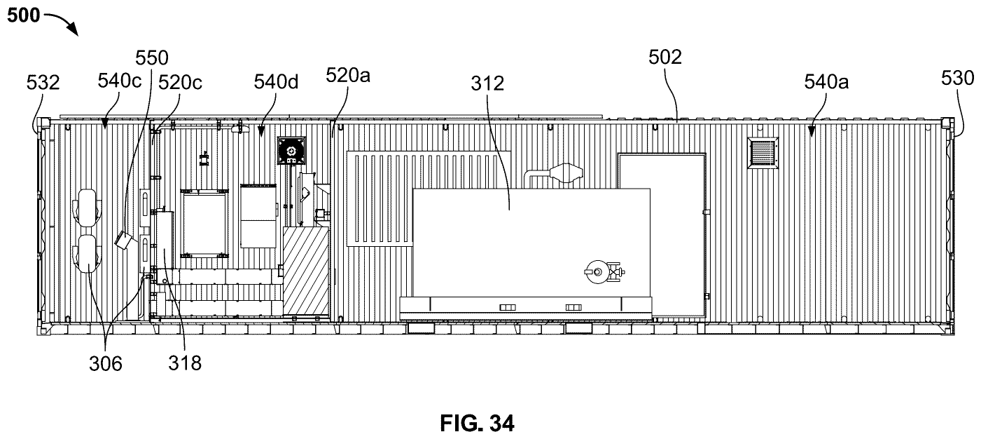

It should be appreciated that the charging system 300 of the charging station 500 can be configured differently than that illustrated in FIGS. 27-32. For example, in some implementations, the charging station 500 can be configured to connect to an external fuel supply (e.g., a gas tank external to the main housing 502 or a gas pipeline connection), as shown in FIGS. 33 and 34, or the charging dispenser 318 of the charging system 300 can be configured to operate the plurality of charging ports 306 as Level 3 chargers, as shown in FIGS. 35-37. Thus, in some examples, the main housing 502 can be configured differently than that illustrated in FIGS. 27-32. For example, in some implementations in which the charging station 500 does not include an internal fuel supply (e.g., as illustrated in FIGS. 34 and 35), the first partition 520a may not be included such that the housing interior compartment 508 does not include the second housing section 540b and the first housing section 540a is adjacent to the first end 530. Similarly, in some implementations in which the charging station 500 is configured as a Level 3 charger, the charging dispenser 318 may be arranged within the third housing section 540c instead of the fourth housing section 540d (e.g., as illustrated in FIGS. 35-37).

In some implementations, devices or systems disclosed herein can be utilized, manufactured, installed, etc. using methods embodying aspects of the invention. Correspondingly, any description herein of particular features, capabilities, or intended purposes of a device or system is generally intended to include disclosure of a method of using such devices for the intended purposes, of a method of otherwise implementing such capabilities, of a method of manufacturing relevant components of such a device or system (or the device or system as a whole), and of a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the invention, of the utilized features and implemented capabilities of such device or system.

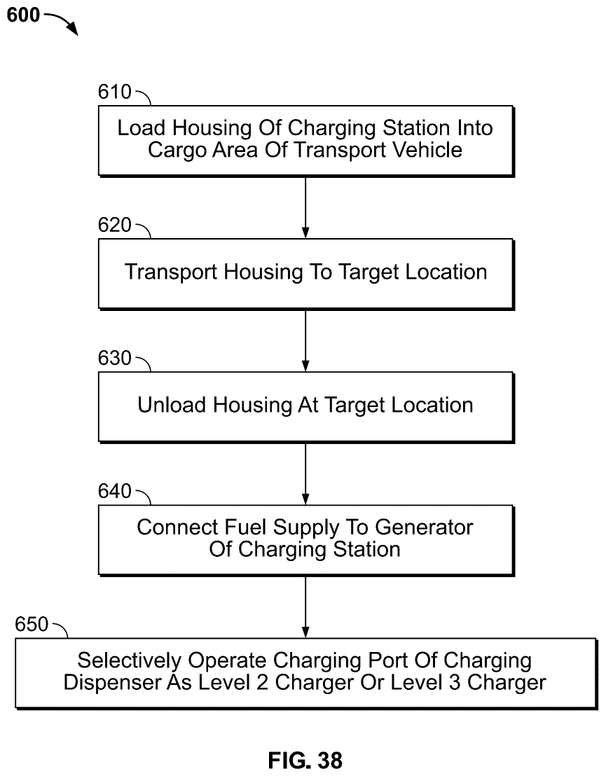

In this regard, FIG. 38 illustrates an example method 600 of for deploying a portable charging station, e.g., any of the charging stations 100, 500 of FIGS. 2-37, to a target location for charging at least one EV at the target location. Block 610 of method 600 can include loading a housing of the portable charging station into a cargo area of a transport vehicle. For example, referring to the charging station 100 illustrated in FIGS. 2-25, block 610 of method 600 can include loading the main housing 102 of the charging station 100 onto a flatbed of a truck (as illustrated in FIG. 3). In other examples, the transport vehicle can be a train and the cargo area can be a rail car of the train. In some examples, the transport vehicle can be a ship and the cargo area can be a hull of the ship. With the main housing loaded into the cargo area, as in block 610, method 600 can further include transporting the housing of the portable charging station to the target location, as in block 620, and unloading the housing of the portable charging station from the cargo area of the transport vehicle to the target location, as in block 630.

Referring still to FIG. 38, with the charging station unloaded at the target location, as in block 630, method 600 can further include connecting a fuel supply to a generator of the portable charging station, as in block 640. For example, in some implementations, the fuel supply can include one or more fuel supply vessels that are disposed within the housing of the portable charging station (e.g., the gas supply 222 of charging station 100 in FIG. 6). In other examples, the fuel supply can be located at the target location, such as a fuel supply pipeline connection (e.g., the fuel supply pipeline 170 of charging station 100 in FIG. 22) or a fuel tank (e.g., the fuel tank 128 in FIG. 8).

With the fuel supply connected to the charging station, as in block 640, method 600 can further include, at block 650, selectively operating, via a controller of the charging station, at least one charging port of a charging dispenser of the charging station as a Level 2 charger or a Level 3 charger using an A/C power output from the generator when the at least one EV is electrically connected to the at least one charging port. For example, referring to the charging system 300 illustrated in FIGS. 26A and 26B, block 650 of method 600 can include selectively operating, via the controller 406, at least one of the charging ports 306 (see FIG. 30) of the charging dispenser 318 as a Level 2 charger or a Level 3 charger using the A/C power output from the generator 312.

In some examples, the at least one charging port of the charging dispenser can be a first charging port and the charging dispenser can further includes a second charging port, and method 600 can further include selectively operating, via the controller, the second charging port as a Level 2 charger or a Level 3 charger using the A/C power output from the generator when the at least one EV is electrically connected to the second charging port. In some such examples, the charging dispenser can include at least three charging ports and the controller can be further configured to selectively operate each charging port of the at least three charging ports, via the A/C power output from the generator, as a Level 2 charger or a Level 3 charger. In some such examples, the at least three charging ports can include at least five charging ports, and the controller can be further configured to, based on signals received from the charging dispenser, operate each charging port of the at least five charging ports as Level 2 chargers.

In some examples, the controller can be configured to, based on signals received from the charging dispenser, operate each charging port of the at least three charging ports as Level 3 chargers. In some such examples, the at least three charging ports can include at least twenty charging ports, and the controller can be configured to, based on signals received from the charging dispenser, operate each charging port of the at least twenty charging ports as Level 3 chargers.

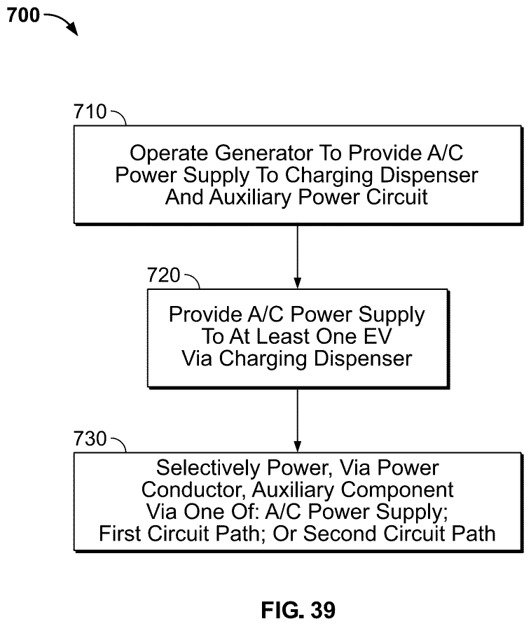

FIG. 39 illustrates an example method 700 for charging at least one EV via a portable charging station that includes a generator that is powered by a fuel supply, such as any of the charging stations 100, 500 of FIGS. 2-37, according to examples of the present disclosure. Block 710 of method 700 can include operating the generator to provide an A/C power supply to a charging dispenser, which can be configured to be electrically connected to the at least one EV to charge the at least one EV, and to an auxiliary power circuit that includes a power conductor. For example, with reference charging system 300 illustrated in FIGS. 26A and 26B, block 710 of method 700 can include operating the generator 312 to provide the A/C power supply the charging dispenser 318 and to the auxiliary power circuit 400 that includes the power conductor 402.

With the generator operating, as in block 710, method 700 can further include, at block 720, providing the A/C power supply to at least one EV via the charging dispenser. For example, in some implementations, block 710 can include supplying A/C power to the charging dispenser which is electrically connected to an EV via one or more charging ports of the charging dispenser (see, e.g., charging ports 306 of charging station 500 in FIG. 30).

From block 720, method 700 can further include, at block 730, selectively powering, via a controller in communication with the power conductor, one or more auxiliary components of the charging station via one of: the generator, the first circuit path, or the second circuit path. For example, with reference again to the charging system 300 illustrated in FIGS. 26A and 26B, block 730 of method 700 can include selectively powering, via the controller 406, the auxiliary components 408 via one of the A/C power supply from the generator 312, the first circuit path 404a, or the second circuit path 404b. It should be appreciated that, in some cases, blocks 710 and 720 could be simultaneous.

In some examples, the A/C power supply can be provided in parallel to the charging dispenser and the auxiliary power circuit. In some examples, the charging station can include the second additional power source that can be an A/C power input that is removably connectable to the second circuit path, and the charging station can be configured to operate without a connection to the A/C power input. In some examples, the one or more auxiliary components can include one or more of: a light source, a thermostat, a humidistat, an electrical outlet, or an HVAC system.

In some examples, the charging station can include the first additional power source that can be at least one battery, and the charging station can further include a third additional power source that is configured to recharge the at least one battery. In some such examples, the third additional power source can be at least one solar panel or at least a portion of the A/C power output from the generator.

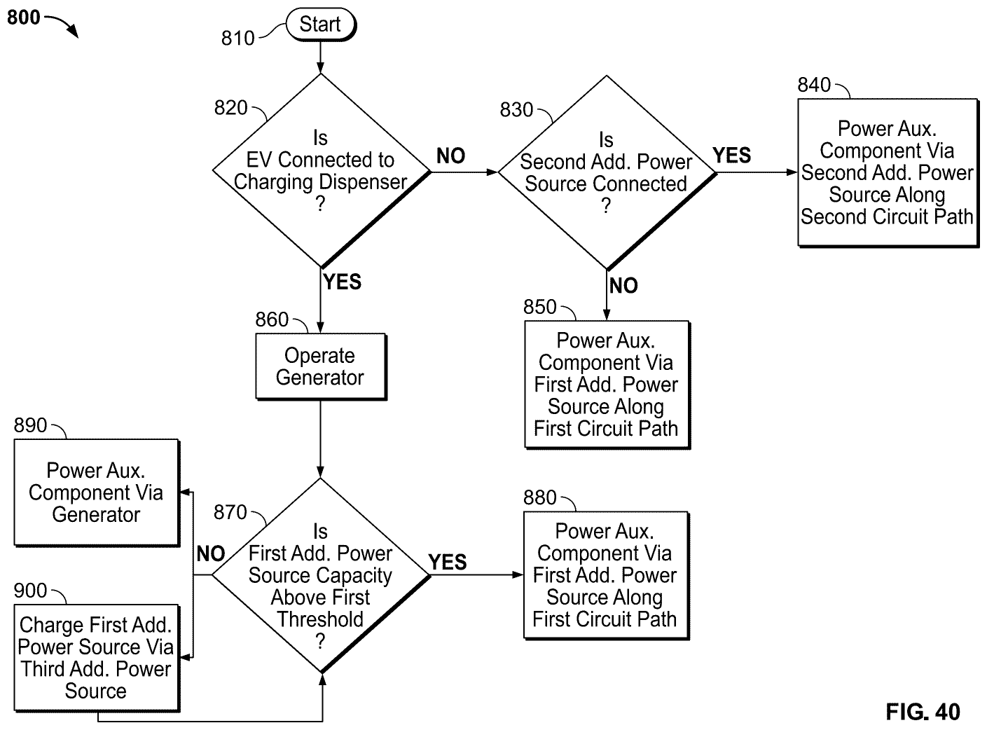

It should be appreciated that a charging station can be configured to power one or more auxiliary components thereof via one or more power sources. In this regard, FIG. 40 illustrates an example method 800 for powering one of more auxiliary components of a portable charging station, e.g., that includes a generator that is powered by a fuel supply, such as any of the charging stations 100, 500 of FIGS. 2-37, according to examples of the present disclosure. Method 800 can begin at block 810, from which it is determined if an EV is connected to a charging dispenser of the charging station, as in block 820. If the determination at block 820 is no, method 800 can advance to block 830, in which it is determined if a second additional power source (e.g., the utility power input 426 of the charging system 300 of FIG. 26A) of the charging station is connected. If the determination at block 830 is yes, method 800 can advance to block 840, which can include powering the auxiliary components via a second additional power source along a second circuit path (e.g., the utility power input 426 of the charging system 300 of FIG. 26A). On the other hand, if the determination at block 830 is no, method 800 can instead advance to block 850, which can include powering the auxiliary components of the charging station via a first additional power source along a first circuit path (e.g., the battery bank 422 of the charging system 300 of FIG. 26A).

If the determination at block 820 is yes (i.e., an EV is connected to the charging dispenser), method 800 can instead advance to block 860, which can include operating a generator of the charging station. With the generator operating, as in block 860, method 800 can advance to block 870, at which it is determined if a capacity of the first additional power source (e.g., the battery bank 422) is above a first threshold capacity level.

If the determination at block 870 is yes, method 800 can advance to block 880, which can include powering the auxiliary components via the first additional power source along the first circuit path. On the other hand, if the determination at block 870 is no, method 800 can instead advance to block 890, which can include powering the auxiliary components via the generator, and to block 900, which can include recharging the first additional power source via a third additional power source (e.g., a portion of output power from the generator).

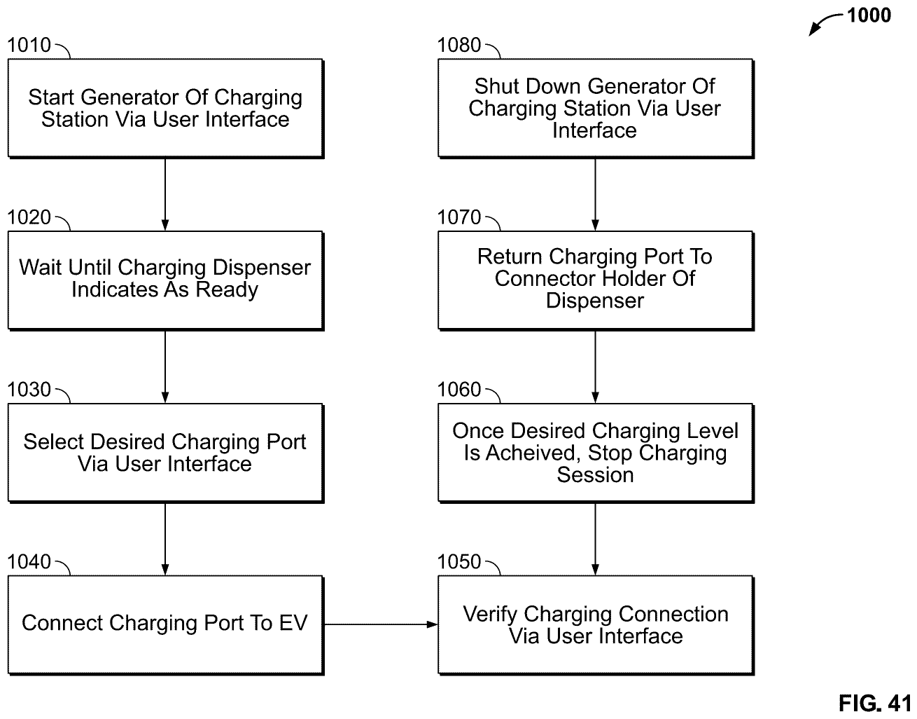

It should be appreciated that a portable charging station for charging one or more EVs can be operated by a user in various ways. In this regard, FIG. 41 illustrates an example method 1000 for operating a portable charging station, e.g., that includes a generator that is powered by a fuel supply, to charge at least one EV, such as any of the charging stations 100, 500 of FIGS. 2-37, according to examples of the present disclosure. Method 1000 can begin at block 1010, which can include starting a generator of the charging station via a user interface. For example, with reference to the charging station 500 illustrated in FIGS. 27-32 having the charging system 300 illustrated in FIGS. 26A and 26B, block 1010 of method 1000 can include starting the generator 312 via the user interface 550 (see FIG. 30). In some examples, the user interface 550 can include a user input (e.g., a button or command on a graphical display thereof) that can receive the user input corresponding to a command to start the generator 312.

With the generator started, as in block 1010, method 1000 can further include waiting a predetermined amount of time until a charging dispenser of the charging station indicates that it is ready, as in block 1020. For example, with reference again to the charging station 500 illustrated in FIGS. 27-32, in some implementations, the charging dispenser 318 or the charging ports 306 can include an indicator (e.g., a light-emitting diode (LED), or the like) that can indicate when a charging port 306 is ready to be connected to the EV. In other examples, the user interface 550 can be configured to notify a user when the charging port 306 is ready to be connected to the EV.

With the charging dispenser ready, as in block 1020, method 1000 can further include selecting a desired charging port via the user interface, as in block 1030, connecting the selected charging port to an EV, as in block 1040, and verifying a charging connection between the selected charging port and the EV has been established, e.g., via the user interface, as in block 1050. For example, with reference again to the charging station 500 illustrated in FIGS. 27-32, in some implementations, the user interface 550, the charging dispenser 318, or one or more of the charging ports 306 can be configured to indicate that a charging connection has been properly established with the EV.

Once a desired charging level of the EV has been achieved (e.g., via indication of the user interface, the charging dispenser, or a system of the EV), method 1000 can further include stopping the charging session (e.g., via the user interface), as in bock 1060, and returning the charging port to a connector holder of the charging dispenser, as in block 1070. With the charging session stopped and the charging port returned, as in blocks 1060, 1070, method 1000 can further include shutting down the generator of the charging station, e.g., via the user interface, as in block 1080. For example, with reference again to the charging station 500 illustrated in FIGS. 27-32, in some implementations, the user interface 550 can be configured to receive a user input corresponding to a command to stop the particular charging session of the EV with the charging port 306 and can automatically cause operation of the generator 312 to stop in response to receiving such command.

In some implementations, aspects of the disclosed technology, including computerized implementations of methods according to the present disclosure, can be implemented as a system, method, apparatus, or article of manufacture using standard programming or engineering techniques to produce software, firmware, hardware, or any combination thereof to control a processor device (e.g., a serial or parallel general purpose or specialized processor chip, a single- or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, aspects of the disclosed technology can be implemented as a set of instructions, tangibly embodied on a non-transitory computer-readable media, such that a processor device can implement the instructions based upon reading the instructions from the computer-readable media. Some implementations of the disclosed technology can include (or utilize) a control device such as an automation device, a special purpose or general purpose computer including various computer hardware, software, firmware, and so on, consistent with the discussion below. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.). In some implementations, a control device can include a centralized hub controller that receives, processes and (re) transmits control signals and other data to and from other distributed control devices (e.g., an engine controller, an implement controller, a drive controller, etc.), including as part of a hub-and-spoke architecture or otherwise.

The term “article of manufacture” as used herein is intended to encompass a computer program accessible from any computer-readable device, carrier (e.g., non-transitory signals), or media (e.g., non-transitory media). For example, computer-readable media can include but are not limited to magnetic storage devices (e.g., hard disk, floppy disk, magnetic strips, and so on), optical disks (e.g., compact disk (CD), digital versatile disk (DVD), and so on), smart cards, and flash memory devices (e.g., card, stick, and so on). Additionally, it should be appreciated that a carrier wave can be employed to carry computer-readable electronic data such as those used in transmitting and receiving electronic mail or in accessing a network such as the Internet or a local area network (LAN). Those skilled in the art will recognize that many modifications may be made to these configurations without departing from the scope or spirit of the present disclosure.

Certain operations of methods according to the present disclosure, or of systems executing those methods, may be represented schematically in the Figures or otherwise discussed herein. Unless otherwise specified or limited, representation in the Figures of particular operations in particular spatial order may not necessarily require those operations to be executed in a particular sequence corresponding to the particular spatial order. Correspondingly, certain operations represented in the Figures, or otherwise disclosed herein, can be executed in different orders than are expressly illustrated or described, as appropriate for particular example implementations of the disclosed technology. Further, in some implementations, certain operations can be executed in parallel, including by dedicated parallel processing devices, or separate computing devices configured to interoperate as part of a large system.

As used herein in the context of computer implementation, unless otherwise specified or limited, the terms “component,” “system,” “module,” “block,” “device,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

The foregoing is considered as illustrative only of the principles of the disclosed technology. Furthermore, since numerous modifications and changes will readily occur to those skilled in the art, it is not desired to limit the disclosure to the exact construction and operation shown and described. While the preferred implementation has been described, the details may be changed without departing from the scope of the present disclosure.

1. A system for charging at least one electric vehicle (EV), the system comprising:
a generator powered by a fuel supply to provide an alternating current (A/C) power output;
a charging dispenser electrically connected with the generator and configured to electrically connect with the at least one EV to charge the at least one EV via the A/C power output from the generator;
an auxiliary power circuit electrically connected with the generator and including a power conductor configured to provide a first circuit path adapted for connection to a first additional power source and a second circuit path adapted for connection to a second additional power source, the first and second additional power sources being independent of the generator;
one or more auxiliary components in electrical communication with the power conductor to power the one or more auxiliary components; and
a controller in electrical communication with the generator, the charging dispenser, and the power conductor,
wherein the power conductor is further configured to selectively power the one or more auxiliary components via one of: the generator, the first circuit path, or the second circuit path.

2. The system of claim 1, wherein the auxiliary power circuit is electrically connected with the generator in parallel with the charging dispenser.

3. The system of claim 1, wherein the power conductor comprises a transfer switch that is configured to be moveable between a first configuration, in which the one or more auxiliary components are powered via the generator or the first circuit path, and a second configuration, in which the one or more auxiliary components are powered via the second circuit path.

4. The system of claim 3, wherein the controller is configured to, based on signals received from at least the first and second additional power sources, cause the transfer switch to move between the first and second configurations.

5. The system of claim 4, wherein the transfer switch is further configured to automatically move from the first configuration to the second configuration based on signals received from the second additional power source.

6. The system of claim 1, wherein the system includes the first additional power source, and the first additional power source comprises at least one battery.

7. The system of claim 6, wherein the at least one battery powers the one or more auxiliary components via the first circuit path independent of the generator and the second additional power source.

8. The system of claim 6, wherein the system further includes a third additional power source that is configured to recharge the at least one battery.

9. The system of claim 8, wherein the third additional power source comprises at least one solar panel.

10. The system of claim 9, wherein the at least one solar panel is configured to recharge the at least one battery independent of the A/C power output from the generator and the second additional power source.

11. The system of claim 8, wherein the third additional power source is at least a portion of the A/C power output from the generator.

12. The system of claim 1, wherein the system includes the second additional power source, and wherein the second additional power source comprises an A/C power input that is removably connectable to the second circuit path.

13. The system of claim 12, wherein the A/C power input powers the one or more auxiliary components via the second circuit path independent of the generator and the first additional power source.

14. The system of claim 12, wherein the system is configured to operate without connection to the A/C power input.

15. The system of claim 3, wherein the power conductor further comprises a voltage adjuster in electrical connection with the generator and the transfer switch,
wherein the voltage adjuster is configured to modify the A/C power output from the generator to an A/C power supply that is provided to the transfer switch to power the one or more auxiliary components.

16. The system of claim 15, wherein the voltage adjuster is a transformer configured to step down the A/C power output.

17. The system of claim 16, wherein the A/C power output from the generator is 480V and the A/C power supply from the transformer is 240V.

18. The system of claim 15, wherein the system includes the first additional power source, and the first additional power source comprises at least one battery, and
wherein the A/C power supply from the voltage adjuster is provided to the transfer switch to power the one or more auxiliary components or to the at least one battery to recharge the at least one battery.

19. The system of claim 3, wherein the power conductor further comprises:
a voltage adjuster in electrical connection with the generator and the transfer switch, the voltage adjuster being configured to modify the A/C power output provided by the generator to provide an A/C power supply; and
an inverter in electrical connection with the voltage adjuster and the transfer switch, the inverter being configured to, with the transfer switch in the first configuration, selectively power the one or more auxiliary components via the A/C power supply from the voltage adjuster or the first circuit path.

20. The system of claim 1, wherein the fuel supply is renewable natural gas or compressed natural gas.

21. The system of claim 1, wherein the one or more auxiliary components includes one or more of: a light source, a thermostat, a humidistat, an electrical outlet, or a heating, ventilation, and air conditioning (HVAC) system.

22. The system of claim 1, wherein the charging dispenser is a modular charging dispenser having a power dispensing capacity that is variably customizable.

23. The system of claim 22, wherein the power dispensing capacity of the charging dispenser is about 30 kilowatts (KW) to about 3,000 kW, inclusive.

24. The system of claim 23, wherein the power dispensing capacity of the charging dispenser is about 30 kW to about 1,000 kW, inclusive.

25. The system of claim 24, wherein the power dispensing capacity of the charging dispenser is about 200 kW to about 600 KW, inclusive.

26. The system of claim 22, wherein the modular charging dispenser comprises:
a charging dispenser input that receives the A/C power output from the generator;
a plurality of power modules that each receive at least a portion of the A/C power output from the charging dispenser input; and
a charging dispenser output in electrical communication with each power module of the plurality of power modules and is configured to provide at least a portion of the A/C power output of the plurality of power modules to the at least one EV to charge the at least one EV,
wherein the power dispensing capacity of the modular charging dispenser is variably customizable based on a number of power modules of the plurality of power modules that are included in the charging dispenser.

27. The system of claim 26, wherein each of power modules of the plurality of power modules is configured to modify the at least portion of the A/C power output as a direct current (D/C) power output that is provided to the at least one EV.

28. The system of claim 26, wherein the modular charging dispenser further comprises one or more charging ports that is electrically connected to the charging dispenser output and is configured to electrically connect to the at least one EV.

29. The system of claim 28, wherein the one or more charging ports includes at least two charging ports.

30. The system of claim 29, wherein the controller is in electrical communication with the plurality of power modules of the charging dispenser, and
wherein the controller is further configured to, based on signals received from the charging dispenser, variably control the power output provided by each charging port of the at least two charging ports via control of the plurality of power modules.

31. The system of claim 29, wherein at least some of the plurality of power modules are configured to selectively modify the at least portion of the A/C power output as a direct current (D/C) power output that is provided to the at least one EV.

32. The system of claim 31, wherein the at least two charging ports includes a first charging port and a second charging port, and
wherein the controller is configured to, based on signals received from the charging dispenser, operate the first and second charging ports as a Level 2 charger or a Level 3 charger.

33. The system of claim 31, wherein the at least two charging ports includes at least three charging ports, and
wherein the controller is configured to, based on signals received from the charging dispenser, selectively operate each charging port of the at least three charging ports as a Level 2 charger or a Level 3 charger.

34. The system of claim 33, wherein the at least three charging ports includes at least five charging ports, and
wherein the controller is configured to, based on signals received from the charging dispenser, operate each charging port of the at least five charging ports as a Level 2 charger.

35. The system of claim 1, wherein the generator is configured to operate with a prime running power rating and the A/C power output is at least about 100 kW.

36. The system of claim 35, wherein the A/C power output is at least about 180 kW.

37. The system of claim 1, wherein the generator comprises a plurality of generators, and
wherein the controller is further configured to:
determine a present load of the charging dispenser; and
control the plurality of generators based on the determined present load of the charging dispenser.

38. The system of claim 8, wherein the system further includes a fourth additional power source in electrical communication with the charging dispenser, and
wherein the controller is further configured to:
determine a present load of the charging dispenser; and
control the fourth additional power source based on the determined present load to provide a supplemental power output to the charging dispenser in addition to the A/C power output from the generator.

39. The system of claim 38, wherein the fourth additional power source comprises at least one supplemental battery that is rechargeable via the third additional power source or the generator.

40. The system of claim 1, wherein the system is further configured to electrically connect with an external electrical system to power the external electrical system via the A/C power output from the generator.

41. The system of claim 40, wherein the external electrical system is included in a house or a mobile home.

42. The system of claim 1, wherein the fuel supply is a fuel pipeline that is external to the system.

43. A portable charging station for charging at least one electric vehicle (EV), the charging station comprising:
a housing;
a generator housed within the housing and powered by a fuel supply to provide an alternating current (A/C) power output;
a charging dispenser electrically connected with the generator and including at least one charging port that is configured to electrically connect with the at least one EV to charge the at least one EV via the A/C power output from the generator;
an auxiliary power circuit electrically connected with the generator and including a power conductor configured to provide a first circuit path adapted for connection to a first additional power source and a second circuit path adapted for connection to a second additional power source, the first and second additional power sources being independent of the generator;
one or more auxiliary components in electrical communication with the power conductor to power the one or more auxiliary components; and
a controller in electrical communication with the generator, the charging dispenser, and the power conductor,
wherein the power conductor is further configured to selectively power the one or more auxiliary components via one of: the generator, the first circuit path, or the second circuit path.

44. The charging station of claim 43, wherein the auxiliary power circuit is electrically connected with the generator in parallel with the charging dispenser.

45. The charging station of claim 43, wherein the fuel supply comprises one or more fuel storage vessels in connection with the generator.

46. The charging station of claim 45, wherein the one or more fuel storage vessels are housed within the housing.

47. The charging station of claim 45, wherein the one or more fuel storage vessels are external to the housing.

48. The charging station of claim 43, wherein the fuel supply comprises a fuel supply connector of a fuel pipeline that is external to the housing.

49. The charging station of claim 43, wherein the one or more auxiliary components includes one or more of: a heating, air conditioning, and ventilation (HVAC) system, a light source, a thermostat, an electrical outlet, or a humidistat.

50. The charging station of claim 43, wherein the charging station includes the first additional power source, and the first additional power source is at least one battery.

51. The charging station of claim 50, wherein the charging station further includes a third additional power source that is configured to recharge the at least one battery, and
wherein the third additional power source comprises at least one solar panel or at least a portion of the A/C power output from the generator.

52. The charging station of claim 43, wherein the charging station includes the second additional power source, and wherein the second additional power source comprises an A/C power input that is removably connectable to the second circuit path.

53. The charging station of claim 43, wherein the generator is configured to operate with a prime running power rating and the A/C power output is at least about 100 kilowatts (KW).

54. The charging station of claim 53, wherein the A/C power output is at least about 180 kW.

55. The charging station of claim 43, wherein the at least one charging port includes a first charging port and a second charging port, and
wherein the controller is further configured to, via control of the charging dispenser, operate the first charging port as a Level 3 charger and the second charging port as a Level 2 charger.

56. The charging station of claim 55, wherein the at least one charging port further includes a third charging port, and
wherein the controller is further configured to, via control of the charging dispenser, operate the third charging port as a Level 2 charger or a Level 3 charger.

57. The charging station of claim 43, wherein the housing has a first housing section and a second housing section, the second housing section being adjacent to a first end of the housing and being separated from the first section by a first partition.

58. The charging station of claim 57, wherein at least the generator is disposed within the first housing section, and
wherein the fuel supply comprises one or more fuel supply vessels that are disposed within the second housing section.

59. The charging station of claim 58, wherein the housing further has a third housing section that is adjacent to the first housing section and a second end of the housing, opposite the first end, the third housing section being separated from the second housing section by a second partition, and
wherein the charging dispenser is disposed within the third housing section.

60. The charging station of claim 59, wherein the housing further has a fourth housing section that is disposed between the first and third housing sections, the fourth housing section being separated from the first housing section by the second partition and from the third housing section by a third partition, and
wherein at least some of the one or more auxiliary components are disposed within the fourth housing section.

61. The charging station of claim 59, wherein the first and second ends of the housing include a first door and a second door, respectively, such that the one or more fuel supply vessels and the charging dispenser are accessible to a user from an exterior of the housing via the first and second doors, respectively.

62. The charging station of claim 43, wherein the housing is configured to be transportable via a transport vehicle.

63. The charging station of claim 43, wherein a length of the housing is less than about 100 feet (ft.).

64. The charging station of claim 63, wherein the length of the housing is about 20 ft. to about 53 ft., inclusive.

65. The charging station of claim 64, wherein the length of the housing is about 40 ft.

66. The charging station of claim 43, wherein a width of the housing is less than about 20 ft.

67. The charging station of claim 66, wherein the width of the housing is about 8 ft. to about 10 ft., inclusive.

68. A method for charging at least one electrical vehicle (EV) via a portable charging station that includes a generator that is powered by a fuel supply, the method comprising:
operating the generator to provide an alternating current (A/C) power supply to a charging dispenser, which is configured to be electrically connected to the at least one EV to charge the at least one EV, and to an auxiliary power circuit that includes a power conductor, which is configured to provide a first circuit path adapted for connection to a first additional power source and a second circuit path adapted for connection to a second additional power source; and
selectively powering, via a controller in communication with the power conductor, one or more auxiliary components of the charging station via one of: the generator, the first circuit path, or the second circuit path.

69. The method of claim 68, wherein the A/C power supply is provided in parallel to the charging dispenser and the auxiliary power circuit.

70. The method of claim 68, wherein the charging station includes the second additional power source, and wherein the second additional power source comprises an A/C power input that is removably connectable to the second circuit path, and
wherein the charging station is configured to operate without a connection to the A/C power input.

71. The method of claim 68, wherein the one or more auxiliary components includes one or more of: a light source, a thermostat, a humidistat, an electrical outlet, or a heating, ventilation, and air conditioning (HVAC) system.

72. The method of claim 68, wherein the charging station includes the first additional power source that comprises at least one battery.

73. The method of claim 72, wherein the charging station further includes a third additional power source that is configured to recharge the at least one battery.

74. The method of claim 73, wherein the third additional power source comprises at least one solar panel or at least a portion of the A/C power output from the generator.

75. A method for deploying a portable charging station to a target location for charging at least one electrical vehicle (EV) at the target location, the method comprising:
loading a housing of the portable charging station into a cargo area of a transport vehicle;
transporting the housing of the portable charging station to the target location;
unloading the housing of the portable charging station from the cargo area of the transport vehicle to the target location;
connecting a fuel supply to a generator of the portable charging station; and
selectively operating, via a controller of the charging station, at least one charging port of a charging dispenser of the charging station as a Level 2 charger or a Level 3 charger using an alternating current (A/C) power output from the generator when the at least one EV is electrically connected to the at least one charging port.

76. The method of claim 75, wherein the fuel supply comprises one or more fuel supply vessels that are disposed within the housing of the portable charging station.

77. The method of claim 75, wherein the fuel supply is located at the target location.

78. The method of claim 75, wherein the at least one charging port of the charging dispenser is a first charging port, and the charging dispenser further includes a second charging port, and wherein the method further comprises:
selectively operating, via the controller, the second charging port as a Level 2 charger or a Level 3 charger using the A/C power output from the generator when the at least one EV is electrically connected to the second charging port.

79. The method of claim 78, wherein the charging dispenser includes at least three charging ports, and
wherein the controller is further configured to selectively operate each charging port of the at least three charging ports, via the A/C power output from the generator, as a Level 2 charger or a Level 3 charger.

80. The method of claim 79, wherein the at least three charging ports includes at least five charging ports, and
wherein the controller is further configured to, based on signals received from the charging dispenser, operate each charging port of the at least five charging ports as Level 2 chargers.

81. The method of claim 79, wherein the controller is configured to, based on signals received from the charging dispenser, operate each charging port of the at least three charging ports as Level 3 chargers.

82. The method of claim 81, wherein the at least three charging ports includes at least twenty charging ports, and
wherein the controller is configured to, based on signals received from the charging dispenser, operate each charging port of the at least twenty charging ports as Level 3 chargers.

83. The method of claim 75, wherein the transport vehicle is a truck, and the cargo area is a flatbed of the truck.

84. The method of claim 75, wherein the transport vehicle is a train, and the cargo area is a rail car of the train.

85. The method of claim 75, wherein the transport vehicle is a ship, and the cargo area is a hull of the ship.

86. A system for charging at least one electric vehicle (EV), the system comprising:
a prime mover having a fuel input and a power output, the fuel input being in connection with a natural gas pipeline; and
at least one charging port in electrical communication with the power output of the prime mover and powered by the prime mover.

87. The system of claim 86, further comprising:
a gas meter in fluid connection with the fuel input of the prime mover.

88. The system of claim 86, further comprising:
a charging dispenser in electrical communication with the power output and the at least one charging port, the charging dispenser being disposed electrically between the power output and the at least one charging port.

89. The system of claim 86, wherein the prime mover is one of an alternating current (A/C) generator, a direct current (D/C) generator, a linear generator, or a microturbine.

90. A system for charging at least one electric vehicle (EV), the system comprising:
a generator powered by a fuel supply to provide an alternating current (A/C) power output;
a charging dispenser electrically connected with the generator and configured to electrically connect with the at least one EV to charge the at least one EV via the A/C power output from the generator;
an auxiliary power circuit electrically connected with the generator and including a power conductor configured to provide a first circuit path adapted for connection to a first additional power source and a second circuit path adapted for connection to a second additional power source, the first and second additional power sources being independent of the generator;
one or more auxiliary components in electrical communication with the power conductor to power the one or more auxiliary components; and
a controller in electrical communication with the generator, the charging dispenser, and the power conductor,
wherein the power conductor is further configured to selectively power the one or more auxiliary components via one of: the generator, the first circuit path, or the second circuit path, and
wherein the system is configured to electrically connect with an external electrical system to power the external electrical system via the A/C power output from the generator.

91. A portable charging station for charging at least one electric vehicle (EV), the charging station comprising:
a housing;
a generator housed within the housing and powered by a fuel supply to provide an alternating current (A/C) power output;
a charging dispenser electrically connected with the generator and including at least one charging port that is configured to electrically connect with the at least one EV to charge the at least one EV via the A/C power output from the generator;
an auxiliary power circuit electrically connected with the generator in parallel with the charging dispenser and including a power conductor configured to provide a first circuit path adapted for connection to a first additional power source and a second circuit path adapted for connection to a second additional power source, the first and second additional power sources being independent of the generator;
one or more auxiliary components in electrical communication with the power conductor to power the one or more auxiliary components; and
a controller in electrical communication with the generator, the charging dispenser, and the power conductor,
wherein the power conductor is further configured to selectively power the one or more auxiliary components via one of: the generator, the first circuit path, or the second circuit path, and
wherein the fuel supply comprises a fuel supply connector of a fuel pipeline that is external to the housing.

92. A portable charging system, comprising:
a prime mover having a fuel input and a power output, the fuel input being in connection with a natural gas pipeline;
at least one charging port in electrical communication with the power output of the prime mover and powered by the prime mover, the at least one charging port being adapted for connection to at least one electric vehicle (EV) to charge the at least one EV via power from the prime mover; and
an auxiliary connector in electrical communication with the power the power output of the prime mover and powered by the prime mover, the auxiliary connector being adapted for connection to an external power system to power the external power system from the prime mover; and
a controller in electrical communication with the prime mover, the at least one charging port and the external power system connector, the controller being configured to selectively provide power from the prime mover to one of the at least one charging port or the auxiliary connector.

93. The charging system of claim 92, wherein the external power system is included in a home or a mobile home.

94. The charging system of claim 92, wherein the controller is further configured to:
detect an electrical connection between the at least one charging port and the at least one EV;
detect an electrical connection between the auxiliary connector and the external power system; and
if the electrical connection between the at least one charging port and the at least one EV is detected, automatically prioritize power to be supplied to the at least one charging port over the auxiliary connector.
